(19) United States
(12) Patent Application Publication
(10) Pub. No.: US 2025/0155343 A1
(43) Pub. Date: May 15, 2025

(54) TESTING APPARATUS AND TESTING METHOD FOR DISPLAY APPARATUS

(71) Applicant: SAMSUNG DISPLAY CO., LTD., YONGIN-SI (KR)

(72) Inventors: Hyunchul Kim, YONGIN-SI (KR); Byoungyul Shim, YONGIN-SI (KR); Seungpyo Hong, YONGIN-SI (KR)

(21) Appl. No.: 18/779,496

(22) Filed: Jul. 22, 2024

(30) Foreign Application Priority Data
Nov. 10, 2023 (KR) 10-2023-0155892

(51) Int. Cl. G01N 3/303

(52) U.S. Cl. CPC G01N 3/303; G01N 2203/0033; G01N 2203/0206; G01N 2203/0262

(57) ABSTRACT

Provided is a testing apparatus for a display apparatus comprising a base, a hit unit mounted on the base to translate in a first direction, a second direction, and a third direction perpendicular to each other, and a pad unit mounted on the base to rotate around each of a first axis perpendicular to an upper surface of the base and a second axis perpendicular to the first axis, wherein the display apparatus is disposed on the pad unit and includes flat and curved areas.

### CROSS-REFERENCE TO RELATED APPLICATION

This application is based on and claims priority under 35 U.S.C. § 119 to Korean Patent Application No. 10-2023-0155892, filed on Nov. 10, 2023, in the Korean Intellectual Property Office, the disclosure of which is incorporated by reference herein in its entirety.

### BACKGROUND

### 1. Field of the Disclosure

The present disclosure generally relates to a testing apparatus for a display apparatus and a testing method for a display apparatus. More particularly, the present disclosure relates to a testing apparatus and testing method for a display apparatus, in which the display apparatus as a testing target is rotatable along an axis.

### 2. Description of the Related Art

Visual information (i.e., data) can be displayed by a display device. Light emitting diodes can be used by a display device to produce a picture. Display devices have a wide range of applications, and their quality has been improved via the exploration of numerous designs.

The durability of a display apparatus may be tested by applying a hit to a surface of the display apparatus. In this case, a hit may be applied to various areas of the display apparatus, and the hit results thereof may vary depending on the areas to which a hit has been applied. The various areas of the display apparatus may include a curved area having a surface with a curvature, particularly a complex-curved area with a variable curvature.

### SUMMARY

One or more embodiments include a testing apparatus for a display apparatus, capable of testing a display apparatus by hitting a hit body (e.g., a steel ball) on the display apparatus in a curved area, particularly in a complex-curved area. However, this objective is merely an example, and the scope of the disclosure is not limited thereto.

Additional aspects will be set forth in part in the description which follows and, in part, will be apparent from the description, or may be learned by practice of the presented embodiments of the disclosure.

According to one or more embodiments, a testing apparatus for a display apparatus comprises a base, a hit unit mounted on the base to translate in a first direction, a second direction, and a third direction perpendicular to each other, and a pad unit mounted on the base to rotate around a first axis and a second axis, wherein the first axis is perpendicular to an upper surface of the base, and the second axis is perpendicular to the first axis, wherein the display apparatus is disposed on the pad unit.

In an embodiment, the display apparatus may include a flat area and a curved area, and the second axis may rotate around the first axis.

In an embodiment, the testing apparatus may further include a support member attached to the base, a rotating member including a first rotating member and a second rotating member, wherein the first rotating member of the rotating member may be connected to the base, and be rotatable with respect to the base, the second rotating member of the rotating member may be connected to the first rotating member and be rotatable with respect to the first rotating member, and wherein the pad unit may be disposed on the second rotating member.

In an embodiment, the pad unit may be mounted on the base to be rotatable around the first axis, the second axis, and a third axis, and the third axis may be perpendicular to the second axis and may extend in a different direction than the first axis.

In an embodiment, the testing apparatus may further include a socket unit rotating around the first axis with respect to the base, and a sphere unit partially arranged in the socket unit and rotating around the second axis and the third axis, wherein the pad unit may be disposed on the sphere unit.

In an embodiment, the testing apparatus may further include an angle indicating unit configured to read an angular position of the pad unit on the first axis or an angular position of the pad unit on the second axis.

In an embodiment, the testing apparatus may further include an angle fixing unit configured to fix the pad unit at a certain angular position.

In an embodiment, the testing apparatus may further include a fixing unit mounted on the pad unit to fixedly attach the display apparatus to the pad unit together.

In an embodiment, the hit unit may include a hit body arranged to drop toward the display apparatus along a gravity direction.

In an embodiment, the pad unit may include a concave portion arranged in a side or corner of the pad unit, and at least a portion of the concave portion may overlap an edge of the display apparatus.

According to one or more embodiments, a testing method for a display apparatus includes mounting the display apparatus on a testing apparatus for the display apparatus, and dropping a hit body on a desired position of the display apparatus, wherein the testing apparatus includes a base, a hit unit mounted on the base to translate in a first direction, a second direction, and a third direction perpendicular to each other, and a pad unit mounted on the base to rotate around each of a first axis and a second axis, wherein the first axis is perpendicular to an upper surface of the base, and the second axis is perpendicular to the first axis, wherein the display apparatus is disposed on the pad unit.

In an embodiment, the display apparatus may include a flat area and a curved area, and the second axis may rotate around the first axis.

In an embodiment, the testing apparatus may further include a support member attached to the base, a support member attached to the base, a rotating member including a first rotating member and a second rotating member, wherein the first rotating member of the rotating member may be connected to the base, and be rotatable with respect to the base, the second rotating member of the rotating member may be connected to the first rotating member and be rotatable with respect to the first rotating member, and wherein the pad unit may be disposed on the second rotating member.

In an embodiment, the pad unit may be mounted on the base to be rotatable around the first axis, the second axis, and a third axis, and the third direction may be perpendicular to the second axis and may extend in a different direction than the first axis.

In an embodiment, the testing apparatus may further include a socket unit rotating around the first axis with respect to the base, and a sphere unit partially arranged in the socket unit and rotating around the second axis and the third axis, and wherein the pad unit may be disposed on the sphere unit.

In an embodiment, the testing method may further include reading an angular position of the pad unit disposed on the first axis or an angular position of the pad unit disposed on the second axis.

In an embodiment, the testing method may further include fixing the pad unit at a certain angular position.

In an embodiment, the testing apparatus may further include a fixing unit mounted on the pad unit to fixedly attach the display apparatus to the pad unit together.

In an embodiment, the dropping of the hit body on the desired position of the display apparatus may be accomplished by dropping the hit body from a certain height toward the display apparatus along a gravity direction.

According to one or more embodiments, a testing apparatus for a display apparatus comprises a base, first support members fixedly attached to the base, second support members movably attached to the first support members to translate along a first direction, a hit unit movably attached to the second support members to translate along a second direction perpendicular to the first direction, a rotating member including a first rotating member and a second rotating member, and a pad unit mounted on the rotating member to rotate around each of a first axis and a second axis, wherein the first axis is perpendicular to an upper surface of the base, and the second axis is perpendicular to the first axis, wherein the first rotating member of the rotating member is attached to the base, and is rotatable with respect to the base, and the second rotating member of the rotating member is attached to the first rotating member and is rotatable with respect to the first rotating member, and the hit unit is configured to guide a hit body on a desired position of the display apparatus.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view schematically illustrating a display apparatus according to an embodiment;

FIG. 2 is an exploded view schematically illustrating each of a display panel and a cover window of a display apparatus according to an embodiment;

FIG. 3 is a perspective view schematically illustrating a display panel of a display apparatus according to an embodiment;

FIG. 4 is a cross-sectional view of the display apparatus taken along line IV-IV′ of FIG. 1;

FIG. 5 schematically illustrates a testing method for a display apparatus, according to an embodiment;

FIG. 6 is a perspective view illustrating a testing apparatus for a display apparatus, according to an embodiment;

FIGS. 7A, 7B, and 7C are cross-sectional views illustrating a hit unit and an operating method thereof, according to an embodiment;

FIG. 8 is a perspective view illustrating a rotating unit according to an embodiment;

FIG. 9 is a cross-sectional view of the rotating unit illustrated in FIG. 8, according to an embodiment;

FIG. 10 is a cross-sectional view of the rotating unit illustrated in FIG. 8, according to another embodiment;

FIG. 11 is a perspective view illustrating a rotating unit according to another embodiment;

FIG. 12 is a cross-sectional view of the rotating unit illustrated in FIG. 11, according to an embodiment;

FIG. 13 is a perspective view illustrating a pad unit according to an embodiment;

FIG. 14A is a perspective view illustrating a coupling state of a display apparatus, a pad unit, and a fixing unit according to an embodiment;

FIG. 14B is a perspective view illustrating a coupling state of a display apparatus, a pad unit, and a fixing unit according to another embodiment; and

FIGS. 15A to 15E are perspective views illustrating process states of a testing method for a display apparatus, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

The disclosure may include various embodiments and modifications, and particular embodiments thereof are illustrated in the drawings and will be described herein in detail. The effects and features of the disclosure and the accomplishing methods thereof will become apparent from the embodiments described below in detail with reference to the accompanying drawings. However, the disclosure is not limited to the embodiments described below, and may be embodied in various modes.

Hereinafter, embodiments will be described in detail with reference to the accompanying drawings, and in the following description, like reference numerals will denote like elements and redundant descriptions thereof will be omitted for conciseness.

It will be understood that when an element such as a layer, a region, or a plate is referred to as being “on” another element, it may be “directly on” the element or may be “indirectly on” the other element with one or more intervening elements therebetween. In addition, sizes of elements in the drawings may be exaggerated for convenience of description. In other words, because the sizes and thicknesses of elements in the drawings are arbitrarily illustrated for convenience of description, the disclosure is not limited thereto.

As used herein, the x-axis, the y-axis, and the z-axis are not limited to three axes of the rectangular coordinate system and may be interpreted in a broader sense. For example, the x axis, the y axis, and the z axis may be perpendicular to one another or may represent different directions that are not perpendicular to one another.

It will be understood that although terms such as “first” and “second” may be used herein to describe various elements, these elements should not be limited by these terms and these terms are only used to distinguish one element from another element.

As used herein, the singular forms “a,” “an,” and “the” are intended to include the plural forms as well, unless the context clearly indicates otherwise.

It will be understood that terms such as “comprise,” “include,” and “have” used herein specify the presence of stated features or elements, but do not preclude the presence or addition of one or more other features or elements.

As used herein, “A and/or B” represents the case of A, B, or A and B. In addition, “at least one of A and B” represents the case of A, B, or A and B.

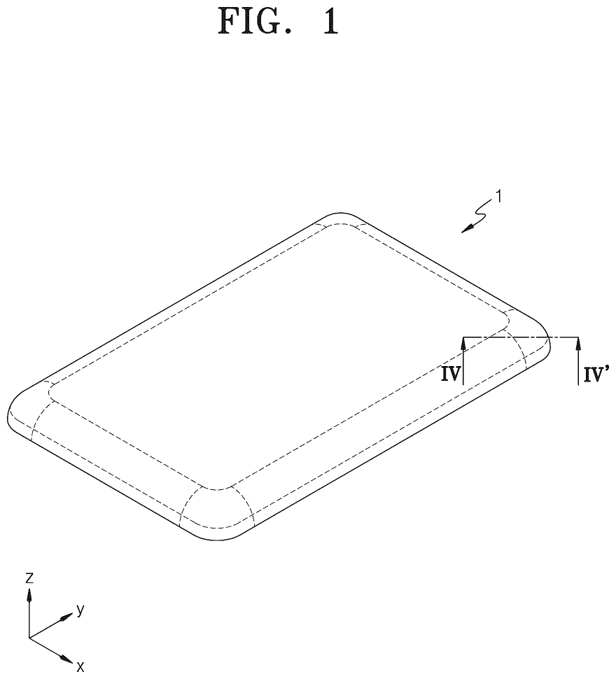

FIG. 1 is a perspective view schematically illustrating a display apparatus according to an embodiment.

Referring to FIG. 1, a display apparatus 1 according to an embodiment is an apparatus displaying a moving image or a still image and is a portable electronic apparatus such as a mobile phone, a smart phone, a tablet personal computer (PC), a mobile communication terminal, an electronic notebook, an electronic book, a portable multimedia player (PMP), a navigation apparatus, or an ultra-mobile PC (UMPC). In addition, the display apparatus 1 may be an electronic apparatus providing a display screen, such as a television, a notebook computer, a monitor, a billboard, or the Internet of Things (IoT). Alternatively, the display apparatus 1 may be a wearable device such as a smart watch, a watch phone, a glasses-type display, or a head-mounted display (HMD).

In an embodiment, the display apparatus 1 may have a rectangular shape in the plan view. In alternative embodiments, the display apparatus 1 may have various shapes including triangular shape, square shape, circular shape, and elliptical shape. In an embodiment, when the display apparatus 1 has a polygonal shape in the plan view, a polygonal corner may be rounded. Hereinafter, for convenience of description, a case where the display apparatus 1 has a rectangular shape with a rounded corner in the plan view is mainly described.

In an embodiment, the display apparatus 1 may have a short side in the x direction and a long side in the y direction. In another embodiment, in the display apparatus 1, the side length of the display apparatus 1 in the x direction and the side length of the display apparatus 1 in the y direction may be equal to each other. In another embodiment, the display apparatus 1 may have, for example, a long side in the x direction and a short side in the y direction. For example, each corner where the short side in the x direction and the long side in the y direction meet each other may be rounded with a certain curvature.

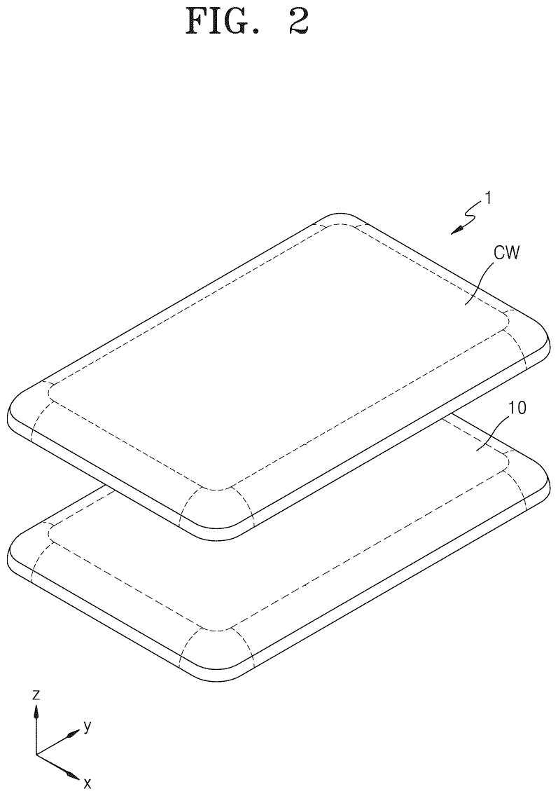

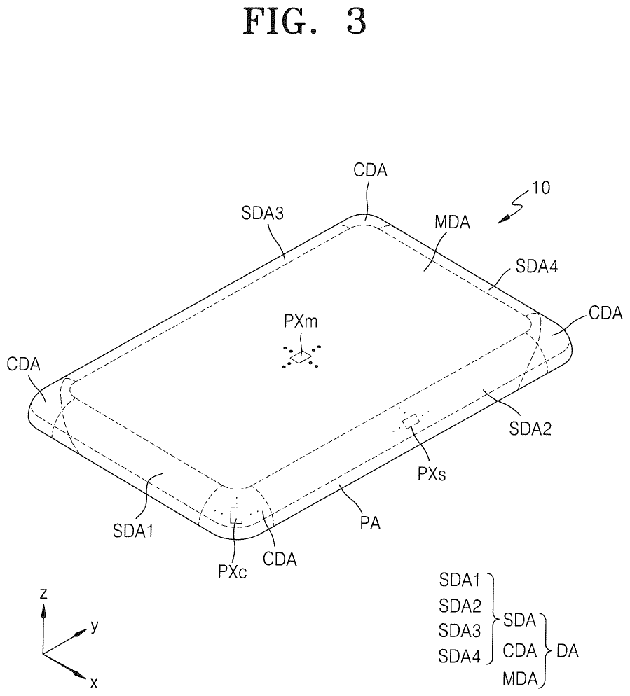

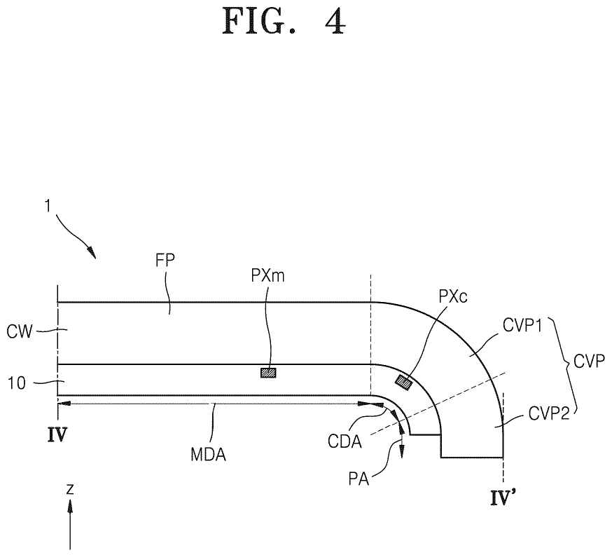

FIG. 2 is an exploded view schematically illustrating each of a display panel and a cover window of a display apparatus according to an embodiment. FIG. 3 is a perspective view schematically illustrating a display panel of a display apparatus according to an embodiment. FIG. 4 is a cross-sectional view of the display apparatus taken along line IV-IV′ of FIG. 1.

As depicted to FIGS. 2 to 4, the display apparatus 1 includes a display panel 10 and a cover window CW disposed on the display panel 10.

The display panel 10 may include a display area having a main display area MDA, a side display area SDA arranged four sides of the main display area MDA, and a corner display area CDA arranged four corners of the main display area MDA. The display panel 10 may include a peripheral area PA surrounding the display area DA. The main display area MDA may be an area arranged at a center portion of the display panel 10 and may be a flat area which is formed without being curved. The main display area MDA may occupy the greatest proportion in the display area DA of the display panel 10 and accordingly may provide most images. The main display area MDA may include a short side in the x direction and a long side in the y direction, and each corner where the short and the long sides meet each other may have a substantially rounded shape.

At least a portion of the side display area SDA may be bent to include a curved surface and may extend outward from each side of the main display area MDA. The side display area SDA may include a first side display area SDA1, a second side display area SDA2, a third side display area SDA3, and a fourth side display area SDA4. In another example, at least one or more of the first side display area SDA1, the second side display area SDA2, the third side display area SDA3, and the fourth side display area SDA4 may be omitted. The first side display area SDA1 may be arranged at a first side of the main display area MDA and curved with a certain curvature. The first side display area SDA1 may extend from the lower side of the main display area MDA in the −y direction. In this case, the first side display area SDA1 may be an area arranged at a lower surface of the display panel 10.

The second side display area SDA2 may be arranged at a second side of the main display area MDA and curved with a certain curvature. The second side display area SDA2 may extend from the right side of the main display area MDA in the +x direction. In this case, the second side display area SDA2 may be arranged at a right surface of the display panel 10.

The third side display area SDA3 may be arranged at a third side of the main display area MDA and curved with a certain curvature. The third side display area SDA3 may extend from the left side of the main display area MDA in the −x direction. In this case, the third side display area SDA3 may be arranged at a left surface of the display panel 10.

The fourth side display area SDA4 may be arranged at a fourth side of the main display area MDA and curved with a certain curvature. The fourth side display area SDA4 may extend from the upper side of the main display area MDA in the −y direction. In this case, the fourth side display area SDA4 may be arranged at an upper surface of the display panel 10.

Each of the first to fourth side display areas SDA1, SDA2, SDA3, and SDA4 may include a curved surface bent with a certain curvature. For example, the first side display area SDA1 and the fourth side display area SDA4 may have a curved surface bent around a bending axis extending in the x direction, and the second side display area SDA2 and the third side display area SDA3 may have a curved surface bent around a bending axis extending in the y direction. Each the curvatures of the first to fourth side display areas SDA1, SDA2, SDA3, and SDA4 may be equal to each other. However, in another example, each the curvatures of the first to fourth side display areas SDA1, SDA2, SDA3, and SDA4 may be different from each other.

The corner display area CDA may extend from a corner of the main display area MDA and curved with a certain curvature. The corner display area CDA may be arranged between the first to fourth side display areas SDA1, SDA2, SDA3, and SDA4. In this example, the display panel 10 may include at least four corners CDAs. For example, the first corner display area CDA may be arranged between the first side display area SDA1 and the second side display area SDA2, the second corner display area CDA may be arranged between the first side display area SDA1 and the third side display area SDA3, the third corner display area CDA may be arranged between the second side display area SDA2 and the fourth side display area SDA4, and the fourth corner display area CDA may be arranged between the third side display area SDA3 and the fourth side display area SDA4.

Because each of the corner display areas CDA may be located between two side display areas SDA having curved surfaces bent in different directions, the corner display area CDA may include a curved surface in which curved surfaces bent in various directions are continuously connected. In addition, when each curvature of adjacent side display areas SDA are different from each other, the curvature of the corner display area CDA may change gradually along the edge of the display apparatus 1. For example, when the curvature of the first side display area SDA1 and the curvature of the second side display area SDA2 are different from each other, the corner display area CDA disposed between the first side display area SDA1 and the second side display area SDA2 may have a curvature that changes gradually according to positions. However, this is only an example, it is not limited thereto.

As depicted in FIG. 3, the display panel 10 may provide an image using a plurality of main pixels PXm arranged in the main display area MDA, a plurality of side pixels PXs arranged in the side display area SDA, and a plurality of corner pixels PXc arranged in the corner display area CDA. In this case, the plurality of main pixels PXm, side pixels PXs, and corner pixels PXc may be implemented as display devices. Each of the main, side, and corner pixels PXm, PXs, PXc may include a red subpixel, a green subpixel, and a blue subpixel. Alternatively, each of the main, side, and corner pixels PXm, PXs, PXc may include a red subpixel, a green subpixel, a blue subpixel, and a white subpixel.

A separate image may be provided or a portion of an image may be provided in each of the main display area MDA, the side display area SDA, and the corner display area CDA. As such, because the display panel 10 provides images in the main display area MDA, the side display area SDA, and the corner display area CDA, the proportion of the display area DA in the display apparatus 1 may increase. That is, in the display apparatus 1 of the same size, the area of the peripheral area PA may decrease and the area of the display area DA may increase.

The peripheral area PA may be arranged entirely or partially to surround along the periphery of the side display area SDA and the corner display area CDA. The peripheral area PA may be an area where an image is not arranged, and various lines and driving circuits may be arranged therein. A shielding layer such as a light blocking member may be provided in the peripheral area PA and may be not visually recognized.

As depicted in FIG. 4, the cover window CW may be disposed on a front surface of the display panel 10. In this case, the ‘front surface’ of the display panel 10 may be defined as a surface facing a direction in which the display panel 10 provides an image. For example, in the main display area MDA, the front surface faces the +z direction (i.e., thickness direction) that is a direction in which an image is provided.

The cover window CW may cover and protect the display panel 10. The cover window CW may have a high transmittance to transmit light emitted from the display panel 10 and have a small thickness to minimize the weight of the display apparatus 1. In addition, the cover window CW may have high rigidity and hardness to protect the display panel 10 from an external impact or force.

The cover window CW may include a transparent material. The cover window CW may be made of, for example, glass or plastic. In this case, when the cover window CW may include plastic, the cover window CW may be flexible. For example, the cover window CW may include ultra-thin glass (UTG®) whose rigidity is reinforced by a method such as chemical reinforcement or thermal reinforcement. In another example, the cover window CW may include colorless polyimide (CPI). In an embodiment, the cover window CW may have a structure in which a flexible polymer layer is arranged on one surface of a glass substrate or may include only a polymer layer.

The cover window CW may include a flat portion FP corresponding to the main display area MDA of the display panel 10 and a curved portion CVP corresponding to the side display area SDA and corner display area CDA. In this example, the flat portion FP may be disposed on the main display area MDA of the display panel, and the curved portion CVP may be disposed on the side display area SDA and corner display area CDA.

More particularly, the flat portion FP of the cover window CW may be provided as a flat surface and may overlap the main display area MDA of the display panel 10. The curved portion CVP of the cover window CW includes a curved surface. In this case, the curved portion CVP may have a constant curvature. However, in another example, the curved portion CVP may have a variable curvature. The curved portion CVP may include a first curved portion CVP1 and a second curved portion CVP2. The first curved portion CVP1 may be arranged to overlap the side display area SDA and the corner display area CDA of the display panel 10. The second curved portion CVP2 may be arranged to overlap the peripheral area PA of the display panel 10. The first curved portion CVP1 may be arranged between the flat portion FP and the second curved portion CVP2. FIG. 4 illustrates that the thickness of the cover window CW is uniform across the flat portion FP and the curved portion CVP. However, in another example, the thickness of the flat portion FP and the thickness of the curved portion CVP may vary, and thus, the thickness of the first curved portion CVP1 and the thickness of the second curved portion CVP2 may be different from each other.

A light blocking member (not illustrated herein) may be arranged at a portion of the second curved portion CVP2 of the cover window CW to overlap the peripheral area PA of the display panel 10. In this case, the light blocking member may include a light blocking material. For example, the light blocking member may include a resin including carbon black, carbon nanotubes, or black dye. The light blocking member may block the components of the display panel 10 arranged in the peripheral area PA from being visible to a user.

The display panel 10 may be disposed below the cover window CW. The cover window CW and the display panel 10 may be coupled through an adhesive member (not illustrated herein). The adhesive member may include an optically clear adhesive (OCA) film or an optically clear resin (OCR). In some embodiments, a lower protection film (not illustrated herein) to protect the display panel 10 may be further disposed under the display panel 10.

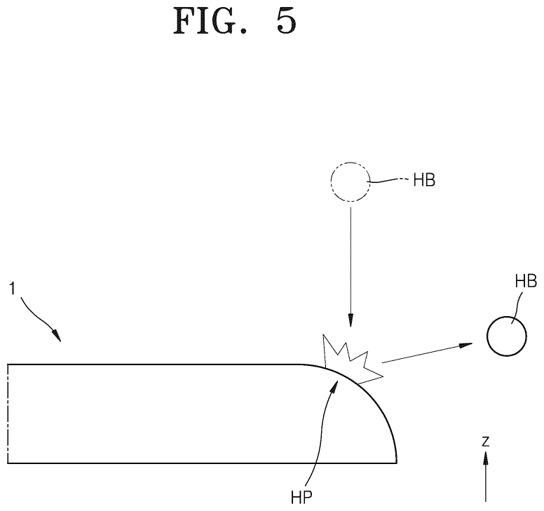

FIG. 5 schematically illustrates a testing method for a display apparatus according to an embodiment.

In this case, as depicted in FIG. 4, a hit is applied to the surface of the display apparatus 1 to test the hardness and/or rigidity of the surface of the display apparatus 1 such as the surface of the cover window CW. For this purpose, a hit body HB may be applied to the surface of the display apparatus 1 as an example of a hit.

In an embodiment, gravity may be used so that the hit body HB is applied to the surface of the display apparatus 1. In an embodiment, the gravity may be applied along the +z direction which may be the opposite to gravity, and the hit body HB may be initially located above display apparatus 1 along the −z direction. In an embodiment, the hit body HB may be a steel ball with a certain weight,

When the hit body HB is dropped from a certain height along the −z-direction of the surface of the display apparatus 1, the hit body HB may be accelerated by gravity toward the display apparatus 1 and may hit on the surface of the display apparatus 1 at a hit point HP. Thereafter, the hit body HB may bounce off from the surface of the display apparatus 1 in a certain direction. After removing the hit body HB that has bounced off, deformation, damage, cracks, and/or the like that have occurred in the display apparatus 1 due to the hit by the hit body HB at the hit point HP may be observed and recorded to evaluate the hardness and rigidity of the display apparatus 1.

When performing the above test, because the hit body HB may move in the gravity direction (−z direction), the position of the hit point HP may be adjusted by suitably adjusting the initial position of the hit body HB. Accordingly, the hit point HP may be located in an area where the surface of the display apparatus 1 may be flat or curved. When the hit point HP is located in an area where the surface of the display apparatus 1 may be flat (e.g., the main display area MDA (see FIG. 3)), the hit body HB may bounce off in the +z direction. When the hit point HP is located in an area where the surface of the display apparatus 1 is curved (e.g., the side display area SDA (see FIG. 3) or the corner display area CDA (see FIG. 3)), the hit body HB may bounce off in a certain direction. However, this is only an example, and the bouncing-off directions may vary depending on each case. FIG. 5 illustrates that the hit point HP is located in an area where the surface of the display apparatus 1 is curved.

In the description with reference to FIG. 5, the direction in which the upper surface of the display apparatus 1 faces, for example, the +z direction, has been described as being the opposite direction of gravity; however, this is merely for convenience of description in describing a method for testing the display apparatus 1 using the hit body HB. In embodiments described below with reference to the following drawings, the display apparatus 1 may form a certain angle with respect to the ground, and the direction in which the lower surface of the display apparatus 1 faces, for example, the −z direction, may be different from the gravity direction.

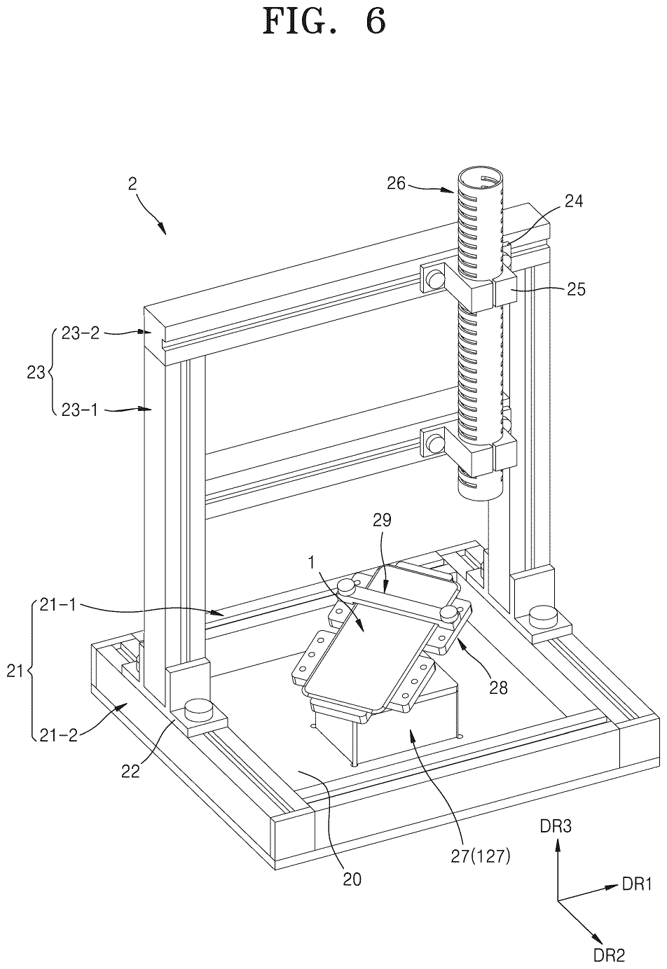

FIG. 6 is a perspective view illustrating a display apparatus testing apparatus according to an embodiment.

As depicted in FIG. 6, a display apparatus testing apparatus 2 includes a base 20, a first support unit 21, a first moving unit 22, a second support unit 23, a second moving unit 24, a third support unit 25, a hit unit 26, a rotating unit 27, a pad unit 28, and a fixing unit 29.

Other components of the display apparatus testing apparatus 2 may be mounted on the upper surface of the base 20. In an embodiment, the base 20 may have a substantially rectangular shape including sides extending in a first direction DR1 and a second direction DR2 respectively. In an embodiment, the base 20 may have a substantially square shape in which the length of a side extending in the first direction DR1 and the length of a side extending in the second direction DR2 may be equal to each other. In an embodiment, the upper surface of the base 20 may face in a third direction DR3 and may be parallel to the ground. In other words, the third direction DR3 may be a direction vertically outward from the ground and may be a direction opposite to the gravity direction. However, in another example, the base 20 may have a different shape depending on the shape of the display apparatus 1.

The first support unit 21 may be fixedly attached to the base 20. For example, the first support unit 21 may be disposed on the upper surface of the base 20 (or the surface facing in the third direction DR3). In an embodiment, the first support unit 21 may have a frame shape overlapping each of the edges of the base 20. In an embodiment, the first support unit 21 may include portions extending in the first direction DR1 and the second direction DR2. For example, the first support unit 21 may include a 1st-1 support unit 21-1 extending in the first direction DR1 and a 1st-2 support unit 21-2 extending in the second direction DR2. In an embodiment, two 1st-1 support units 21-1 and two 1st-2 support units 21-2 may be disposed on the base 20 to form the frame shape. In an embodiment, a length scale in the second direction DR2 may be indicated on some of the portions of the first support unit 21, for example, on the 1st-2 support unit 21-2. In an embodiment, each of the portions of the first support unit 21 (e.g., the 1st-1 and 1st-2 support units 21-1 and 21-2) may include a profile and include grooves arranged on the surface facing in a certain direction (e.g., the third direction DR3).

The first moving unit 22 may be movably attached to the first support unit 21. For example, the first moving unit 22 is disposed over the upper surface of the first support unit 21 (or the surface facing in the third direction DR3). In this case, the first moving unit 22 may be disposed on both of the 1st-2 support units 21-2. In an embodiment, the first moving unit 22 may be coupled to the first support unit 21 to translate and move. For example, the first moving unit 22 translates and moves in the second direction DR2 over the 1st-2 support units 21-2. In an embodiment, each of the 1st-2 support units 21-2 includes grooves extending along the second direction DR2, and each of the first moving units 22 includes a knob bolt. In this case, the first moving unit 22 may be translated and moved along the 1st-2 support unit 21-2 after loosening the knob bolt of the first moving unit 22. In another case, to fix the first moving unit 22 to the 1st-2 support unit 21-2, the knob bolt may be tightened.

In another embodiment, the 1st-2 support unit 21-2 and the first moving unit 22 may include a linear motion guide (LM, not shown herein). In this case, the 1st-2 support unit 21-2 may include a rail, and the first moving unit 22 may include a moving block coupled to the rail. In an embodiment, two first moving units 22 may be provided and may be respectively disposed on the edge of the base 20 in the first direction DR1 and the edge of the base 20 in the opposite direction to the first direction DR1. However, in another example, the number of the first moving unit 22 may be one.

The second support unit 23 may be fixedly attached to each of the first moving units 22. In an embodiment, the second support unit 23 may be coupled to the first moving unit 22 to move together with the first moving unit 22. In an embodiment, the second support unit 23 may be screw-fastened to the first moving unit 22. In an embodiment, the second support unit 23 includes at least one 2nd-1 vertical support unit 23-1 extending in the third direction DR3. In an embodiment, the 2nd-1 vertical support unit 23-1 includes a profile. In an embodiment, a plurality of 2nd-1 vertical support units 23-1 may be provided. For example, the 2nd-1 vertical support units 23-1 may be provided as many as the first moving units 22, and each of the 2nd-1 vertical support units 23-1 may be coupled to the first moving unit 22 corresponding thereto. Accordingly, the 2nd-1 vertical support units 23-1 move in one direction (e.g., the second direction DR2) together with the first moving units 22.

In an embodiment, the second support unit 23 may also include at least one 2nd-2 horizontal support unit 23-2 extending in the first direction DR1. In an embodiment, the 2nd-2 horizontal support unit 23-2 may include a profile. In an embodiment, the 2nd-2 horizontal support unit 23-2 may connect two 2nd-1 vertical support units 23-1 facing each other. In an embodiment, a plurality of 2nd-2 horizontal support units 23-2 may be provided. For example, two 2nd-2 horizontal support units 23-2 spaced apart from each other in the third direction DR3 may be provided, and may be connected to two 2nd-1 vertical support units 23-1 facing each other. That is, one of the 2nd-2 horizontal support units 23-2 may be attached to one end of the 2nd-1 vertical support unit 23-1, and the other of the 2nd-2 horizontal support units 23-2 may be attached to the middle of the 2nd-1 vertical support unit 23-1. Accordingly, because the 2nd-2 horizontal support units 23-2 may be coupled to the 2nd-1 vertical support units 23-1, and the 2nd-1 vertical support units 23-1 may be coupled to the first moving units 22, the 2nd-1 vertical support units 23-1 and the 2nd-2 horizontal support units 23-2 translate and move in a certain direction (e.g., the second direction DR2) together with the first moving units 22. That is, one end of the 2nd-1 vertical support unit 23-1 may be connected to one end of the 2nd-2 horizontal support unit 23-2, and the other end of the 2nd-1 vertical support unit 23-1 may be connected to the first moving units 22

The second moving unit 24 may be coupled to the second support unit 23. In an embodiment, the second moving unit 24 may be disposed on one surface of the 2nd-2 horizontal support unit 23-2 facing in the second direction DR2. In an embodiment, the second moving unit 24 may be coupled to the second support unit 23 to translate and move in the first direction DR1. For example, the second moving unit 24 translates and moves in the first direction DR1 over the 2nd-2 horizontal support unit 23-2. In an embodiment, the 2nd-2 horizontal support unit 23-2 includes grooves extending in the first direction DR1, and the second moving unit 24 includes a knob bolt. In this case, the second moving unit 24 may be translated and moved over the 2nd-2 horizontal support unit 23-2 by loosening the knob bolt of the second moving unit 24, and the second moving unit 24 may be fixed to the 2nd-2 horizontal support unit 23-2 by tightening the knob bolt.

In another embodiment, the 2nd-2 horizontal support unit 23-2 and the second moving unit 24 may include the LM guide. In this case, the 2nd-2 horizontal support unit 23-2 may include a rail, and the second moving unit 24 may include a moving block coupled to the rail. In an embodiment, a plurality (e.g., two) of second moving units 24 may be provided. For example, two second moving units 24 and two 2nd-2 horizontal support units 23-2 may be provided, and the second moving units 24 may be respectively coupled to the 2nd-2 support units 23-2 corresponding thereto in the manner described above.

The third support unit 25 may be connected to the second moving unit 24. In another embodiment, the third support unit 25 may be integrally formed with the second moving unit 24. For example, as illustrated in FIG. 6, the second moving unit 24 is coupled to the 2nd-2 horizontal support unit 23-2 by the knob bolt, and the portion protruding in the second direction DR2 among the components constituting the second moving unit 24 is understood as the third support unit 25. In an embodiment, the third support unit 25 may be configured to form, at a center thereof, a substantially circular opening extending in the third direction DR3. In an embodiment, each of openings facing the third direction DR3 may be defined in the third support unit 25. In an embodiment, each of the openings includes at least one screw hole. In an embodiment, a bolt may be located in the opening, and a nut may be coupled with the bolt. When the bolt-nut coupling is tightened, the diameter of a circular opening through which the third support unit 25 extends in the third direction DR3 decreases. Accordingly, the hit unit 26 arranged in the circular opening may be fixed to the third support unit 25.

In an embodiment, the third support unit 25 may be integrally formed with the second moving unit 24 and thus moves in the first direction DR1 together with the second moving unit 24. In addition, the second moving unit 24 may be connected to the second support unit 23 which may be connected to the first moving unit 22 to move in the second direction DR2. Thus, the third support unit 25 may be translated and moved in the first direction DR1 and the second direction DR2 by the second moving unit 24 and the first moving unit 22.

The hit unit 26 may be coupled to the third support unit 25. In an embodiment, the hit unit 26 may be coupled to the third support unit 25 to be movable in the third direction DR3. In an embodiment, the hit unit 26 may be arranged in a circular opening formed in the third support unit 25 in the third direction DR3. In an embodiment, the hit unit 26 may be fixed to the third support unit 25 by tightening the above bolt-nut coupling. In an embodiment, by loosening the above bolt-nut coupling, the hit unit 26 may be separated from the inner surface of the circular opening of the third support unit 25 and may be moved in the third direction DR3.

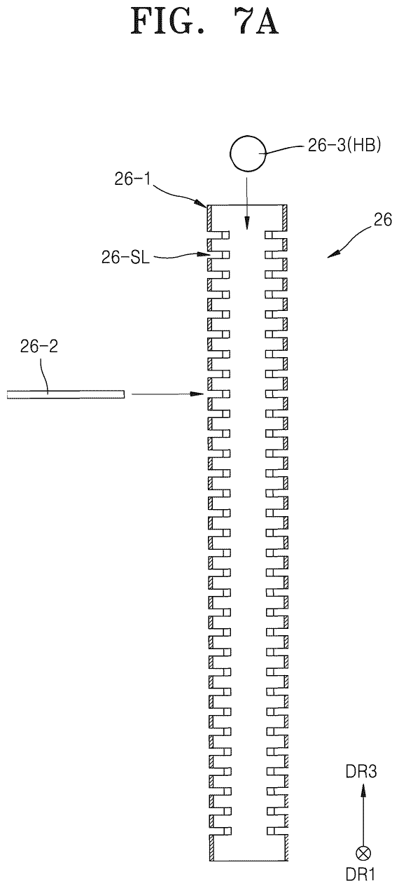

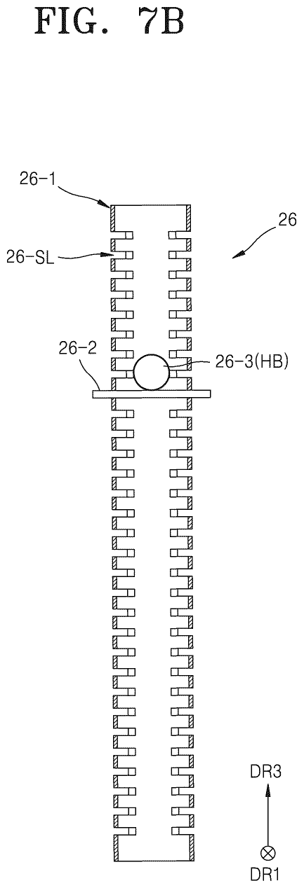

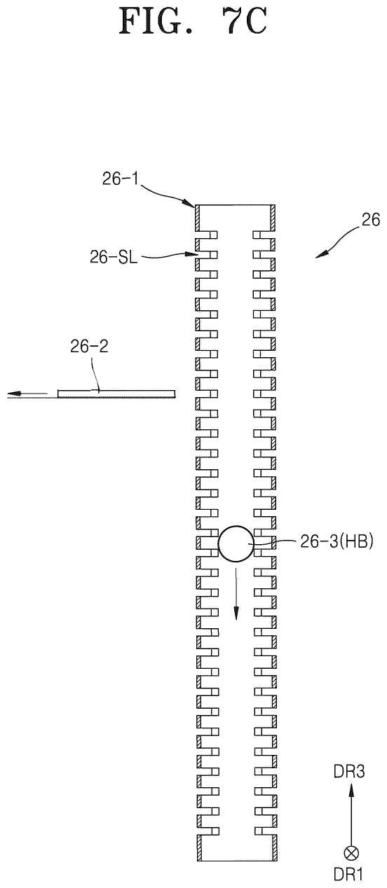

The third support unit 25 may be moved in the second direction DR2 and first direction DR1 by the first and second moving units 22 and 24, and the hit unit 26 may be moved in the third direction DR3 through the above process. Thus, the hit unit 26 may be translated and moved in the second direction DR2, the first direction DR1, and the third direction DR3 by the first moving unit 22, the second moving unit 24, and the third support unit 25. In an embodiment, the first to third directions DR1, DR2, and DR3 may be understood as three directions perpendicular to each other in the rectangular coordinate system. Accordingly, the hit unit 26 may be understood as being translatable and movable in three directions perpendicular to each other. In an embodiment, the hit unit 26 includes a substantially cylindrical tube. However, in another example, the hit unit 26 includes grooves inside of the hit unit 26 to guide a steel ball or the hit body 26-3 (as shown in FIG. 7A).

The rotating unit 27 may be disposed on the base 20. In an embodiment, the rotating unit 27 may be disposed on a center portion of the base 20. In an embodiment, the rotating unit 27 may be arranged in the frame shape formed by the first support unit 21. The rotating unit 27 includes a structure configured to rotate around an axis extending in the third direction DR3.

The pad unit 28 may be disposed on the rotating unit 27. In an embodiment, the pad unit 28 may be coupled to the rotating unit 27 to rotate around the axis of the rotating unit 27. In an embodiment, as a testing target, the display apparatus 1 may be mounted on the pad unit 28. In an embodiment, openings screwed to the rotating unit 27 may be defined in the pad unit 28 which includes openings to which the fixing unit 29 may be screwed.

The fixing unit 29 may be disposed on the pad unit 28. In an embodiment, the fixing unit 29 may be screwed to the pad unit 28. For example, the fixing unit 29 includes, at an inner surface thereof, a plurality of openings including screw holes and knob bolts. In an embodiment, the fixing unit 29 and the pad unit 28 may be screwed to each other by setting at least one of the openings of the fixing unit 29 to overlap at least one of the openings of the pad unit 28 and then tightening the knob bolt. Although not illustrated in FIG. 6, a plurality of fixing units 29 may be provided. In an embodiment, the display apparatus 1 may be interposed between the fixing unit 29 and the pad unit 28, and the display apparatus 1 may be mounted on the pad unit 28 by pressing the display apparatus 1 toward the upper surface of the pad unit 28 by tightening the knob bolt of the fixing unit 29.

As a result, the hit unit 26 may be translated and moved in the first direction DR1, the second direction DR2, and the third direction DR3 by the second moving unit 24, the first moving unit 22, and the third support unit 25. In addition, the display apparatus 1 may be rotatable by the rotating unit 27 while being mounted on the pad unit 28, and accordingly, the angular position thereof may be adjusted.

FIGS. 7A, 7B, and 7C are cross-sectional views illustrating a hit unit and an operating method thereof according to an embodiment.

Referring to FIGS. 7A to 7C, the hit unit 26 includes a guide unit 26-1, a support stick 26-2, and a hit body 26-3. In an embodiment, the hit body 26-3 is the same as the hit body HB (see FIG. 5) described with reference to FIG. 5. In an embodiment, the guide unit 26-1 may refer to a cylindrical tube illustrated as the hit unit 26 in FIG. 6.

In an embodiment, the guide unit 26-1 may be a substantially cylindrical tube. In an embodiment, the hit body 26-3 may be a steel ball with a certain diameter and a weight. In an embodiment, the diameter of the guide unit 26-1 may be greater than the diameter of the hit body 26-3. In an embodiment, the upper and lower sides of the guide unit 26-1 or both ends thereof in the third direction DR3 may be open, and the hit body 26-3 may pass through the guide unit 26-1 in the third direction DR3. In an embodiment, the guide unit 26-1 may include a plurality of slits 26-SL formed at both side surfaces thereof. The slits 26-SL may be spaced apart from each other in the third direction DR3. The slits 26-SL may pass through the side surface of the guide unit 26-1, and the external space and internal space of the guide unit 26-1 may be connected to each other through the slits 26-SL. In an embodiment, the support stick 26-2 may be shaped to fit the slits 26-SL of the guide unit 26-1. In an embodiment, the length of the support stick 26-2 along the first direction DR1 may be greater than the diameter of the guide unit 26-1 so that the support stick 26-3 thoroughly penetrates the guide unit 26-1 along the first direction DR1.

As depicted in FIG. 7A, the support stick 26-2 is inserted into one of the slits 26-SL of the guide unit 26-1, and the hit body 26-3 is put inside of the guide unit 26-1 through the end of the guide unit 26-1 in the third direction DR3. In an embodiment, the third direction DR3 is opposite to the gravity direction. Thus, the hit body 26-3 may moves downward (e.g., in the gravity direction).

Referring to FIG. 7B, because the length of the support stick 26-2 is greater than the diameter of the guide unit 26-1, the support stick 26-2 enters through one of the slits 26-SL of the guide unit 26-1 and exits through the slit 26-SL located on the opposite side thereof. In other words, the support stick 26-2 passes through the guide unit 26-1 in the direction of the diameter of the guide unit 26-1. In an embodiment, the support stick 26-2 is inserted thereinto before the hit body 26-3 passes through the guide unit 26-1 in the opposite direction to the third direction DR3. Accordingly, the support stick 26-2 supports the hit body 26-3 and prevent the hit body 26-3 from dropping thereto. In an embodiment, the height at which the hit body 26-3 is seated (or the position before dropping) is adjusted according to the height of the slit 26-SL of the guide unit 26-1 into which the support stick 26-2 is inserted (or the position in the third direction DR3).

Referring to FIG. 7C, the support stick 26-2 inserted into the slit 26-SL of the guide unit 26-1 is removed therefrom. As the support stick 26-2 supporting the hit body 26-3 is removed, the hit body 26-3 drops in the opposite direction to the third direction DR3. Accordingly, the hit body 26-3 passes through the end of the guide unit 26-1 in the opposite direction to the third direction DR3 and drops toward the display apparatus. The subsequent processes may be the same as those illustrated in FIG. 5.

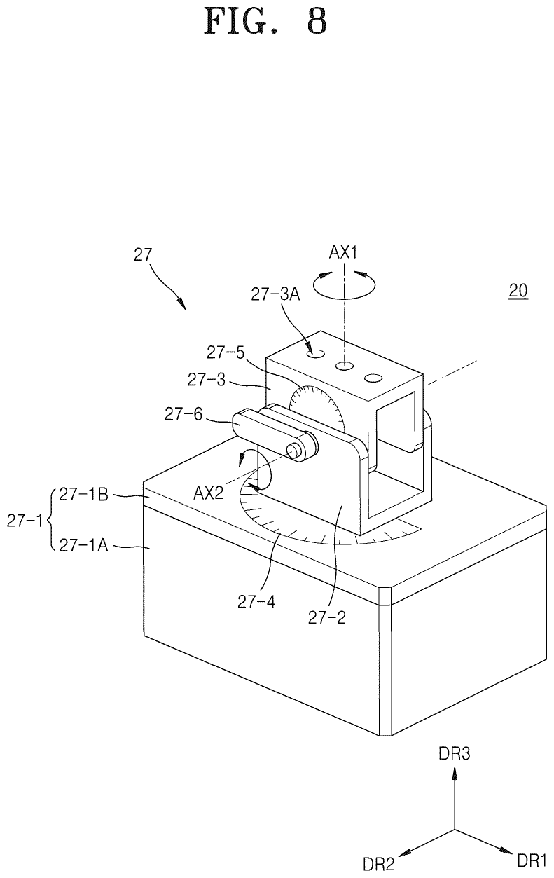

FIG. 8 is a perspective view illustrating a rotating unit according to an embodiment.

Referring to FIG. 8, the rotating unit 27 includes a support member 27-1, a first rotating member 27-2, a second rotating member 27-3, a first angle indicating unit 27-4, a second angle indicating unit 27-5, and a control handle 27-6.

The support member 27-1 may be fixedly attached to the base 20 and may provide a space in which other components of the rotating unit 27 may be arranged. In an embodiment, the support member 27-1 may have a substantially rectangular parallelepiped shape. In an embodiment, support member 27-1 may include rounded edges. In an embodiment, the support member 27-1 may include a first support member 27-1A and a second support member 27-1B. In an embodiment, the second support member 27-1B may be disposed on a top of the first support member 27-1A. In an embodiment, the support member 27-1 may have the shape of a hollow box. In an embodiment, the second support member 27-1B may be fixedly screwed to the first support member 27-1A. However, in another example, the first and second support member 27-1A and 27-1B may be attached together with any method.

The first rotating member 27-2 may be disposed over the support member 27-1. In an embodiment, the first rotating member 27-2 may be disposed on the upper surface of the second support member 27-1B (or the surface facing the third direction DR3). In an embodiment, the first rotating member 27-2 may be coupled to the second support member 27-1B to be rotatable around a first axis AX1 which may be along the third direction DR3. In this case, the first axis AX1 may extend in the third direction DR3. In an embodiment, the first rotating member 27-2 may have an U-shape when viewed from the first direction DR1. For example, the first rotating member 27-2 may be open in the first direction DR1 and in the third direction DR3 as illustrated in FIG. 8. Because the first rotating member 27-2 may rotate around the first axis AX1 along the third direction DR3, the opening direction may also change as well. However, for convenience of description, FIG. 8 illustrates that the first rotating member 27-2 is aligned in the first direction DR1.

The second rotating member 27-3 may be rotatably coupled to the first rotating member 27-2. In an embodiment, the second rotating member 27-3 may be coupled to the first rotating member 27-2 to be rotatable around a second axis AX2. In an embodiment, the second axis AX2 may extend along and rotate around the second direction DR2. Thus, the direction in which the second axis AX2 extends may change accordingly. However, for convenience of description, FIG. 8 illustrates that the second axis AX2 extends in the second direction DR2. In an embodiment, the second rotating member 27-3 may have a shape similar to the overturned shape of the first rotating member 27-2. In an embodiment, the second rotating member 27-3 may include a 2nd-1 opening 27-3A that may be screwed to the pad unit 28 (see FIG. 6) described above.

In an embodiment, the support member 27-1 may be fixedly attached to the base 20. The first rotating member 27-2 may rotate around the first axis AX1 with respect to the support member 27-1 (or the base 20). The second rotating member 27-3 may rotate around the second axis AX2 with respect to the first rotating member 27-2. Thus, the first axis AX1 may be understood as a fixed axis whose orientation does not change, and the second axis AX2 may be understood as a variable axis whose orientation may changes as the first rotating member 27-2 rotates.

The first angle indicating unit 27-4 may be disposed on the support member 27-1. In an embodiment, the first angle indicating unit 27-4 may be arranged between the second support member 27-1B and the first rotating member 27-2. The first angle indicating unit 27-4 may indicate a scale and an angle to read the angular position of the first rotating member 27-2 around the first axis AX1 with respect to the support member 27-1. The first angle indicating unit 27-4 may be directly formed over the second support member 27-1B or may be separately formed and then attached onto the second support member 27-1B together.

The second angle indicating unit 27-5 may be disposed on the second rotating member 27-3. In an embodiment, the second angle indicating unit 27-5 may be arranged between the first rotating member 27-2 and the second rotating member 27-3. The second angle indicating unit 27-5 may indicate a scale and an angle to read the angular position of the second rotating member 27-3 around the second axis AX2 with respect to the first rotating member 27-2. The second angle indicating unit 27-5 may be directly formed over the second rotating member 27-3 or may be separately formed and then attached onto the second rotating member 27-3 together.

The control handle 27-6 may be disposed on an outer surface of the first rotating member 27-2. In an embodiment, the control handle 27-6 may be disposed over the outer surface of the first rotating member 27-2 facing in the second direction DR2. However, when the first rotating member 27-2 rotates around the first axis AX1, the surface of the first rotating member 27-2 where the control handle 27-6 may be arranged faces in a direction different than the second direction DR2. In an embodiment, the control handle 27-6 moves independently with respect to the first rotating member 27-2 and is fixedly attached to the second rotating member 27-3. Accordingly, by operating the control handle 27-6, the angular position of the second rotating member 27-3 around the second axis AX2 with respect to the first rotating member 27-2 may be controlled. In another embodiment, a structure configured to fix the angular position of the second rotating member 27-3 around the second axis AX2 with respect to the first rotating member 27-2 may be additionally provided.

As a whole, the second rotating member 27-3 may be rotatable around the second axis AX2 with respect to the first rotating member 27-2, and the first rotating member 27-2 may be rotatable around the first axis AX1 with respect to the support member 27-1 (or the base 20). Thus, the pad unit 28 (see FIG. 6) which may be attached and coupled to the second rotating member 27-3 may rotate simultaneously or separately around the first axis AX1 and the second axis AX2 with respect to the support member 27-1 (or the base 20).

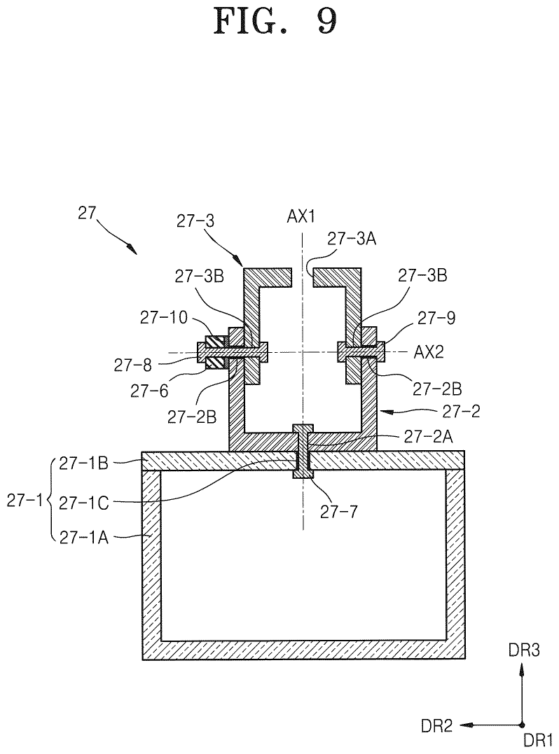

FIG. 9 is a cross-sectional view of the rotating unit illustrated in FIG. 8, according to an embodiment, and

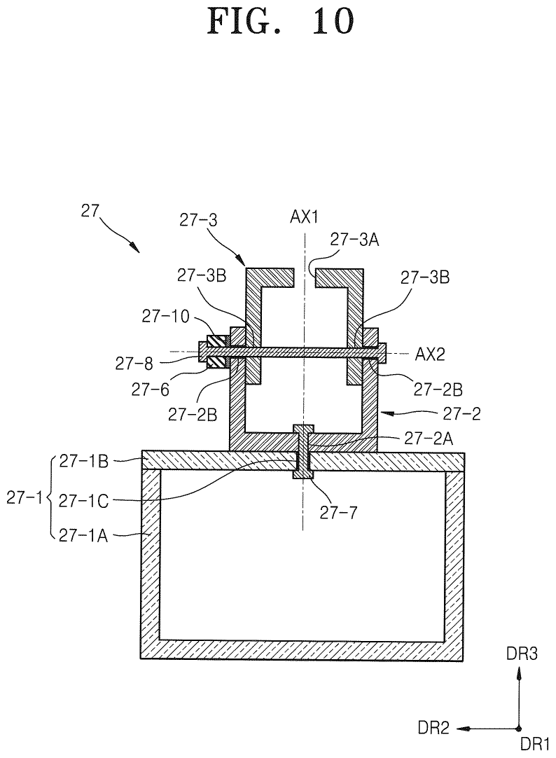

FIG. 10 is a cross-sectional view of the rotating unit illustrated in FIG. 8, according to another embodiment.

FIGS. 9 and 10 illustrate a cross-section of the rotating unit 27 taken along a plane parallel to the second direction DR2 and the third direction DR3. When the first rotating member 27-2 rotates around the first axis AX1, the cross-sectional view taken along the plane changes. However, for convenience of description, FIGS. 9 and 10 illustrate a case where the second axis AX2 is aligned in the second direction DR2.

As depicted in FIG. 9, the support member 27-1 and the first rotating member 27-2 are rotatably attached together through a first connecting member 27-7, and the first rotating member 27-2 and the second rotating member 27-3 are rotatably attached together through a second connecting member 27-8 and a third connecting member 27-9 which is located opposite to the connecting member 27-8 along the second direction DR2.

In an embodiment, the support member 27-1 may have the shape of a substantially hollow box. In an embodiment, the second support member 27-1B may be arranged and coupled on the first support member 27-1A to define an internal hollow space. In an embodiment, a support member opening 27-1C passing through the second support member 27-1B in the third direction DR3 may be defined in the second support member 27-1B.

In an embodiment, the first rotating member 27-2 may include a 1st-1 opening 27-2A passing through the first rotating member 27-2 in the third direction DR3. In an embodiment, the first rotating member 27-2 may include a 1st-2 opening 27-2B passing through the first rotating member 27-2 in the second direction DR2. In an embodiment, a plurality of 1st-2 openings 27-2B may be provided.

In an embodiment, the second rotating member 27-3 may include a 2nd-1 opening 27-3A passing through the second rotating member 27-3 in the third direction DR3. In an embodiment, a plurality of 2nd-1 openings 27-3A may be provided as illustrated in FIG. 8. In an embodiment, the second rotating member 27-3 may include a 2nd-2 opening 27-3B passing through the second rotating member 27-3 in the second direction DR2. In an embodiment, a plurality of 2nd-2 openings 27-3B may be provided.

In an embodiment, the support member opening 27-1C, the 1st-1 opening 27-2A, and the 2nd-1 opening 27-3A may overlap each other along the third direction DR3. In an embodiment, each of the centers of the support member opening 27-1C, the 1^{st}-1 opening 27-2A, and the 2^{nd}-1 opening 27-3A may be located on the same line (e.g., the first axis AX1). In an embodiment, the plurality of 1^{st}-2 openings 27-2B and the plurality of 2^{nd}-2 openings 27-3B overlap each other. In an embodiment, each of the centers of the 1^{st}-2 openings 27-2B and the 2^{nd}-2 openings 27-3B may be located on the same line (e.g., the second axis AX2). At least one of the support member opening 27-1C, the 1^{st}-1 and 1^{st}-2 openings 27-2A and 27-2B, and the 2^{nd}-1 and 2^{nd}-2 openings 27-3A and 27-3B includes a screw hole formed at the inner surface thereof.

The first connecting member 27-7 may connect the first rotating member 27-2 and the second support member 27-1B together so that the first rotating member 27-2 may be rotatable around the first axis AX1 with respect to the support member 27-1. In an embodiment, the first connecting member 27-7 may be partially arranged in the support member opening 27-1C and partially in the 1st-1 opening 27-2A. In an embodiment, the first connecting member 27-7 may be fixed to the first rotating member 27-2 and may be spaced apart from the inner surface of the support member opening 27-1C. Accordingly, the first connecting member 27-7 rotates with respect to the second support member 27-1B together with the first rotating member 27-2. In an embodiment, the first connecting member 27-7 may extend along the first axis AX1. In an embodiment, the 1st-1 opening 27-2A may include a screw hole, and the first connecting member 27-7 may include a bolt and nut structure for fitting the screw hole of the 1st-1 opening 27-2A.

The second connecting member 27-8 and the third connecting member 27-9 may connect the second rotating member 27-3 and the first rotating member 27-2 together so that the second rotating member 27-3 may be rotatable around the second axis AX2 with respect to the first rotating member 27-2. In an embodiment, the second connecting member 27-8 may pass through one of the plurality of 1st-2 openings 27-2B and one of the plurality of 2nd-2 openings 27-3B along the second direction DR2. In an embodiment, the second connecting member 27-8 may be fixedly attached to the second rotating member 27-3 and may be spaced apart from each of the inner surfaces of the 1st-2 opening 27-2B and the 2nd-2 opening 27-3B. In an embodiment, the third connecting member 27-9 may pass through one of the plurality of 1st-2 openings 27-2B and one of the plurality of 2nd-2 openings 27-3B along the second direction DR2. In an embodiment, the third connecting member 27-9 may be fixedly attached to the second rotating member 27-3 and may be spaced apart from each of the inner surfaces of the 1st-2 opening 27-2B and the 2nd-2 opening 27-3B. Accordingly, the second and third connecting members 27-8 and 27-9 rotate with respect to the first rotating member 27-2 together with the second rotating member 27-3. In an embodiment, the second and third connecting members 27-8 and 27-9 may extend along the second axis AX2. In an embodiment, each of the 2nd-2 openings 27-3B may include a screw hole, and each of the second and third connecting members 27-8 and 27-9 may include a bolt and nut structure for fitting the screw hole of the 2nd-2 opening 27-3B corresponding thereto.

In an embodiment, the second connecting member 27-8 may be attached to the control handle 27-6. In an embodiment, the second connecting member 27-8 may be fixedly attached to the control handle 27-6. In an embodiment, the control handle 27-6 may include a screw hole, and the second connecting member 27-8 may include a bolt and nut structure for fitting the screw hole of the control handle 27-6 thereto. Accordingly, the control handle 27-6, the second connecting member 27-8, the third connecting member 27-9, and the second rotating member 27-3 integrally rotate around the second axis AX2 together.

In an embodiment, an angle fixing pad 27-10 may be arranged between the control handle 27-6 and the first rotating member 27-2. In an embodiment, the angle fixing pad 27-10 may include a material with a high friction coefficient. In an embodiment, the control handle 27-6 may be brought into sufficiently close contact with the angle fixing pad 27-10 by tightening the bolt and nut structure of the second connecting member 27-8. In this case, due to the frictional force between the angle fixing pad 27-10 and the control handle 27-6, the second rotating member 27-3 may no longer rotate around the second axis AX2. Accordingly, the angular position of the second rotating member 27-3 on the second axis AX2 may be fixed. In another embodiment, the angle fixing pad 27-10 may be arranged between the first rotating member 27-2 and the second rotating member 27-3. However, in another example, various means for fixing the angular position of the second rotating member 27-3 on the second axis AX2 may be provided.

In an embodiment, the 2nd-1 opening 27-3A includes a screw hole, and the second rotating member 27-3 and the pad unit 28 (see FIG. 6) are coupled using a bolt for fitting the screw hole of the 2nd-1 opening 27-3A.

Referring to FIG. 10, the second connecting member 27-8 may cross through the first rotating member 27-2 and the second rotating member 27-3 in the second direction DR2.

In an embodiment, the second connecting member 27-8 may simultaneously pass through the plurality of 1st-2 openings 27-2B and the plurality of 2nd-2 openings 27-3B along the second direction DR2. In an embodiment, the second connecting member 27-8 may be attached to the second rotating member 27-3 and may be rotatable with respect to the first rotating member 27-2. In an embodiment, the control handle 27-6 may be fixedly attached to the second connecting member 27-8. Thus, as similar to the embodiment illustrated in FIG. 9, the control handle 27-6, the second connecting member 27-8, and the second rotating member 27-3 may integrally rotate around the second axis AX2 together.

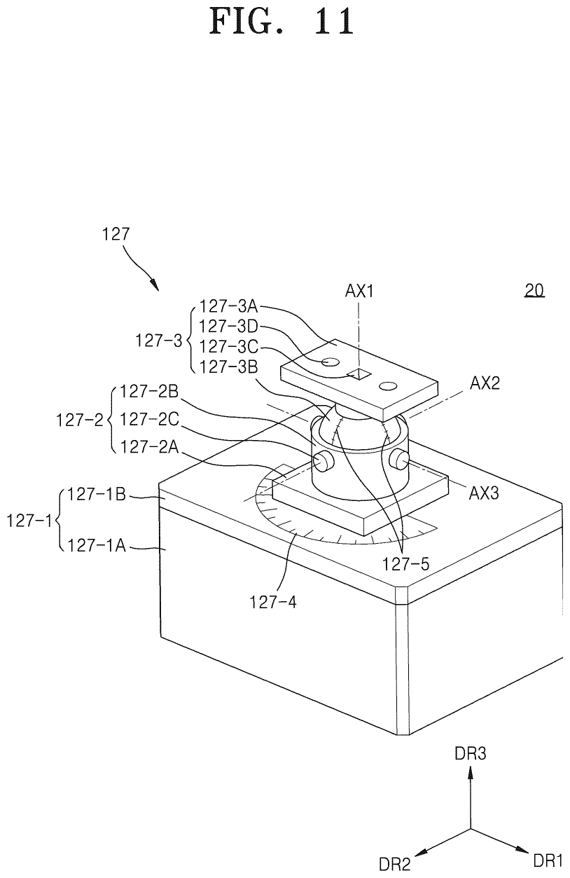

FIG. 11 is a perspective view illustrating a rotating unit according to another embodiment.

Referring to FIG. 11, a rotating unit 127 includes a ball-and-socket joint. The rotating unit 127 includes a support member 127-1, a first rotating member 127-2, a second rotating member 127-3, a first angle indicating unit 127-4, and a second angle indicating unit 127-5.

The support member 127-1 may be fixedly attached on the base 20 and provides a space in which other components of the rotating unit 127 may be arranged. In an embodiment, the support member 127-1 has a substantially rectangular parallelepiped shape. In this case, support member 127-1 includes rounded edges. However, in another example, the support member 127-1 may have other shapes such as a triangular or circular shapes. In an embodiment, the support member 127-1 includes a first support member 127-1A and a second support member 127-1B. In an embodiment, the second support member 127-1B may be disposed on a top of the first support member 127-1A. In an embodiment, the support member 127-1 may have the shape of a hollow box. In an embodiment, the second support member 127-1B may be screwed to the first support member 127-1A. However, in another example, the first and second support member 127-1A and 127-1B may be attached together with any method.

The first rotating member 127-2 may be disposed on the support member 127-1. In an embodiment, the first rotating member 127-2 may be disposed on the upper surface of the second support member 127-1B (or the surface facing the third direction DR3). In an embodiment, the first rotating member 127-2 may be coupled to the second support member 127-1B to be rotatable around a first axis AX1. In an embodiment, the first axis AX1 may extend in the third direction DR3.

The first rotating member 127-2 may include a first plate 127-2A, a socket unit 127-2B, and a fixing pin 127-2C. The first plate 127-2A may be rotatably connected to the support member 127-1, for example, the second support member 127-1B. The socket unit 127-2B may provide a space in which a sphere unit 127-3B of the second rotating member 127-3 described below may be arranged. In an embodiment, the socket unit 127-2B may be fixedly attached to the first plate 127-2A. Thus, the first plate 127-2A and the socket unit 127-2B may integrally rotates around the first axis AX1 with respect to the support member 127-1 (e.g., the second support member 127-1B) together. A plurality of fixing pins 127-2C may be coupled to the socket unit 127-2B. In an embodiment, the fixing pin 127-2C may be used to fix the angular position of the second rotating member 127-3.

The second rotating member 127-3 may be rotatably coupled to the first rotating member 127-2. In an embodiment, the second rotating member 127-3 may be rotatably attached to the first rotating member 127-2 to be rotatable around a second axis AX2 and a third axis AX3. In an embodiment, the second axis AX2 and the third axis AX3 may be perpendicular to each other. In an embodiment, the second axis AX2 and the third axis AX3 may be rotatable around the first axis AX1. Thus, the direction in which the second axis AX2 and the third axis AX3 extend changes accordingly. However, for convenience of description, FIG. 11 illustrates that the second axis AX2 extends in the second direction DR2 and the third axis AX3 extends in the first direction DR1.

The second rotating member 127-3 may include a second plate 127-3A and a sphere unit 127-3B. A 2nd-1 opening 127-3C and a 2nd-2 opening 127-3D may be defined in the second plate 127-3A. The sphere unit 127-3B may be partially arranged in the socket unit 127-2B of the first rotating member 127-2. In an embodiment, the sphere unit 127-3B may be fixedly attached to the second plate 127-3A through the 2nd-1 opening 127-3C. For example, a portion of the sphere unit 127-3B may protrude in the third direction DR3 and may fit the shape of the 2nd-1 opening 127-3C. In an embodiment, the 2nd-1 opening 127-3C may haves a polygonal shape, for example, a square shape, and the second plate 127-3A may not rotate with respect to the sphere unit 127-3B. Thus, the second plate 127-3A and the sphere unit 127-3B may integrally rotate around the second axis AX2 and/or the third axis AX3 with respect to the first rotating member 127-2 (e.g., the socket unit 127-2B) together. In an embodiment, the second rotating member 127-3 may be screwed through the 2nd-2 opening 127-3D to the pad unit 28 (see FIG. 6) described above. However, in another example, the second rotating member 127-3 may be attached to the pad unit 28 through other attaching methods.

In an embodiment, the support member 127-1 may be fixedly attached to the base 20. The first rotating member 127-2 may rotate around the first axis AX1 with respect to the support member 127-1 (or the base 20). The second rotating member 127-3 may rotate around the second axis AX2 and/or the third axis AX3 with respect to the first rotating member 127-2. Thus, the first axis AX1 may be understood as a fixed axis whose orientation does not change, and each of the second axis AX2 and the third axis AX3 may be understood as a variable axis whose orientation may change.

The first angle indicating unit 127-4 may be disposed over the support member 127-1. In an embodiment, the first angle indicating unit 127-4 may be arranged between the second support member 127-1B and the first rotating member 127-2. The first angle indicating unit 127-4 may indicate a scale and an angle to indicate the angular position of the first rotating member 127-2 around the first axis AX1 with respect to the support member 127-1. The first angle indicating unit 127-4 may be directly formed over the second support member 127-1B or may be separately formed and then attached onto the second support member 127-1B together.

The second angle indicating unit 127-5 may be disposed over the second rotating member 127-3. In an embodiment, the second angle indicating unit 127-5 may be disposed over the sphere unit 127-3B. The second angle indicating unit 127-5 may indicate a scale and an angle to read the angular position of the second rotating member 127-3 around the second axis AX2 with respect to the first rotating member 127-2 and the angular position of the second rotating member 127-3 around the third axis AX3 with respect to the first rotating member 127-2. The second angle indicating unit 127-5 may be directly formed over the sphere unit 127-3B. As the sphere unit 127-3B rotates, a portion of the second angle indicating unit 127-5 may be covered by the socket unit 127-2B.

As a whole, the second rotating member 127-3 may be rotatable around the second axis AX2 and/or the third axis AX3 with respect to the first rotating member 127-2, and the first rotating member 127-2 may be rotatable around the first axis AX1 with respect to the support member 127-1 (or the base 20). Thus, the pad unit 28 (see FIG. 6) fixedly attached to the second rotating member 127-3 rotates simultaneously or separately around the first axis AX1, the second axis AX2, and the third axis AX3, with respect to the support member 127-1 (or, the base 20).

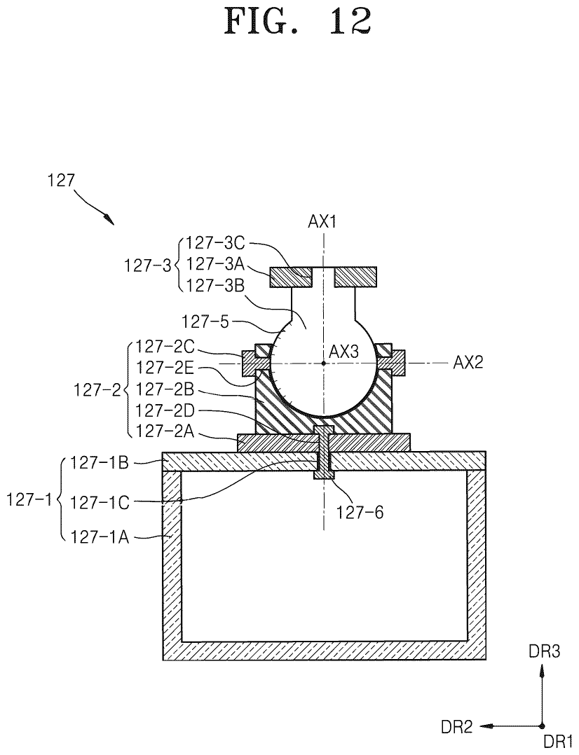

FIG. 12 is a cross-sectional view of the rotating unit illustrated in FIG. 11, according to an embodiment.

FIG. 12 illustrates a cross-section of the rotating unit 127 taken along a plane parallel to the second direction DR2 and the third direction DR3. When the first rotating member 127-2 rotates around the first axis AX1, the cross-sectional view taken along the plane changes. However, for convenience of description, FIG. 12 illustrates a case where the second axis AX2 is aligned in the second direction DR2.

Referring to FIG. 12, the support member 127-1 and the first rotating member 127-2 are attached together through a connecting member 127-6.

In an embodiment, the support member 127-1 may include the first support member 127-1A and the second support member 127-1B, and haves the shape of a substantially hollow box. In an embodiment, the second support member 127-1B coupled with the first support member 127-1A may define an internal space. In an embodiment, a support member opening 127-1C passing through the second support member 127-1B in the third direction DR3 may be defined in the second support member.

In an embodiment, a 1st-1 opening 127-2D passing through the first plate 127-2A in the third direction DR3 may be defined in the first rotating member 127-2. In an embodiment, 1st-2 openings 127-2E passing through the socket unit 127-2B in the first direction DR1 or the second direction DR2 may be defined in the first rotating member 127-2. In an embodiment, a plurality of 1st-2 openings 127-2E may be arranged along the periphery of the socket unit 127-2B. FIG. 12 illustrates only the 1st-2 openings 127-2E passing through the socket unit 127-2B in the second direction DR2.

In an embodiment, the second rotating member 127-3 may include a 2nd-1 opening 127-3C passing through the second plate 127-3A in the third direction DR3. In an embodiment, the support member opening 127-1C, the 1st-1 opening 127-2D, and the 2nd-1 opening 127-3C may overlap each other along the third direction DR3. In an embodiment, the support member opening 127-1C, the 1st-1 opening 127-2D, and the 2nd-1 opening 127-3C may be located on the same line (e.g., the first axis AX1).

The connecting member 127-6 may connect the first rotating member 127-2 and the second support member 127-1B together so that the first rotating member 127-2 is rotatable around the first axis AX1 with respect to the support member 127-1. In an embodiment, the connecting member 127-6 may be partially arranged in the support member opening 127-1C and partially in the 1st-1 opening 127-2D. In an embodiment, the connecting member 127-6 may be fixedly attached to the first rotating member 127-2 and may be spaced apart from the inner surface of the support member opening 127-1C. Accordingly, the connecting member 127-6 may rotate with respect to the second support member 127-1B together with the first rotating member 127-2. In an embodiment, the connecting member 127-6 extends along the first axis AX1. In an embodiment, a screw hole may be defined in the 1st-1 opening 127-2D, and the connecting member 127-6 may include a bolt and nut structure for fitting the screw hole of the 1st-1 opening 127-2D. In another embodiment, the connecting member 127-6 may be integrally formed with the first plate 127-2A.

The sphere unit 127-3B may be non-rotatably connected to the second plate 127-3A. In an embodiment, the sphere unit 127-3B may include a protrusion portion shaped to fit the 2nd-1 opening 127-3C. The sphere unit 127-3B and the second plate 127-3A may be coupled by fitting the protrusion portion and the 2nd-1 opening 127-3C to each other.

A plurality of fixing pins 127-2C may be arranged in the 1st-2 opening 127-2E along the second direction DR2. In an embodiment, the number of 1st-2 openings 127-2E and the number of fixing pins 127-2C may be equal to each other, and each of the fixing pins 127-2C may be coupled to the 1st-2 opening 127-2E corresponding thereto. In an embodiment, the 1st-2 openings 127-3E includes a screw hole, and the fixing pin 127-2C may be a bolt.

In an embodiment, a portion of the sphere unit 127-3B may be arranged in the socket unit 127-2B. With the fixing pin 127-2C released, the sphere unit 127-3B may freely rotate around the second axis AX2 and/or the third axis AX3 in the socket unit 127-2B. In an embodiment, at least some of the fixing pins 127-2C may be closely adhered and fixed toward the sphere unit 127-3B. In this case, the second rotating member 127-3 may be fixed at a corresponding angular position. When the fixing pins 127-2C may be separated from the sphere unit 127-3B, the angular position of the second rotating member 127-3 may be adjusted by rotating the sphere unit 127-3B again.

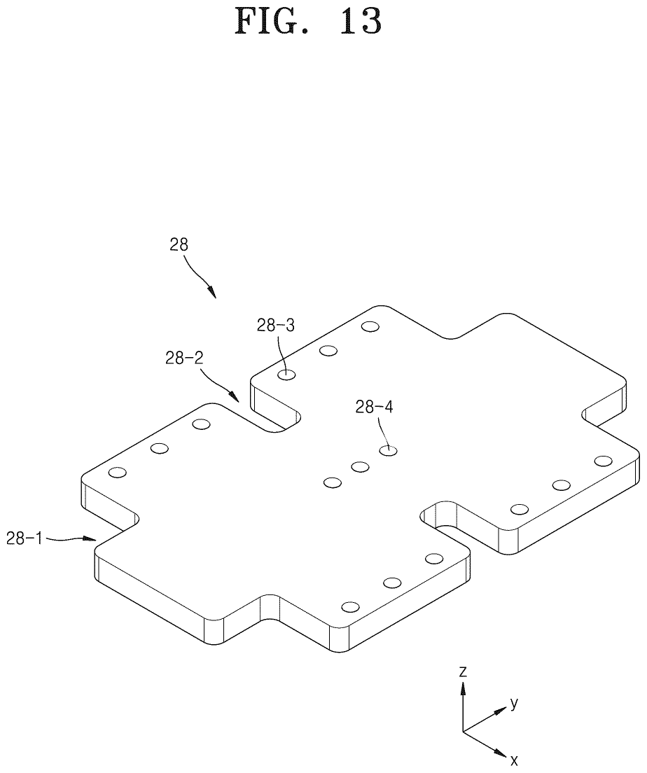

FIG. 13 is a perspective view illustrating a pad unit according to an embodiment.

As referring to FIG. 13, the pad unit 28 includes a long side and a short side. The long side extends in the y direction, and a short side extends in the x direction.

The pad unit 28 may have a substantially rectangular shape with rounded corners and has a shape including a concave portion arranged at each corner and a concave portion arranged on the long side. In an embodiment, the pad unit 28 may include first concave portions 28-1 arranged at the four corners. In an embodiment, the pad unit 28 may include second concave portions 28-2 arranged at the long side and recessed along the x direction. Although not illustrated in FIG. 13, the pad unit 28 may include additional concave portions arranged at the short side and recessed along the y direction.

Referring to FIGS. 3 and 13 together, the first concave portions 28-1 of the pad unit 28 overlaps the corner display areas CDA of the display panel 10 described above along the z direction. In an embodiment, the second concave portions 28-2 of the pad unit 28 overlaps the side display areas SDA of the display panel 10 described above along the z direction, for example, the second side display area SDA2 and/or the third side display area SDA3.

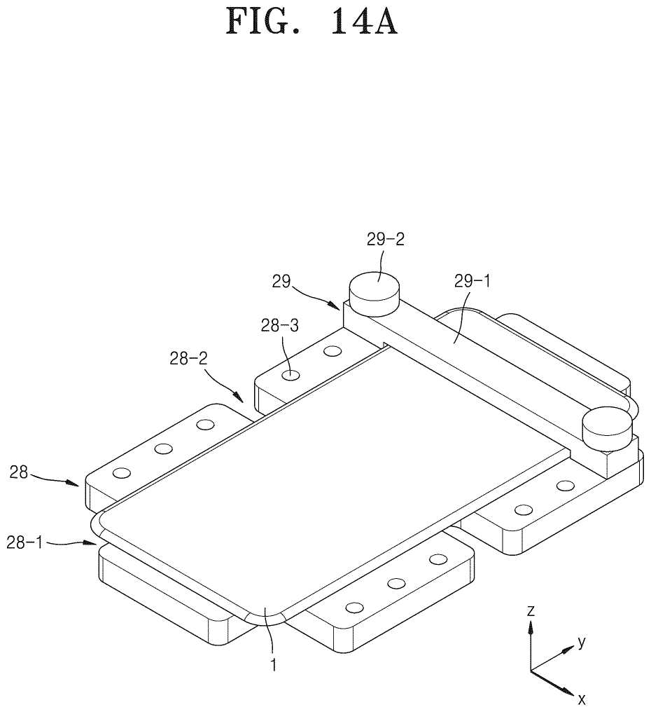

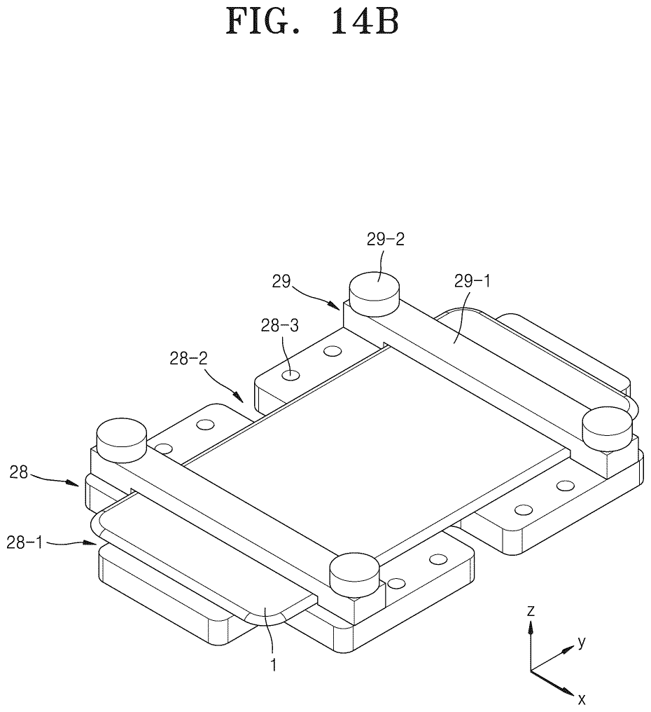

The pad unit 28 may include a plurality of first coupling portions 28-3 arranged along the long side. In an embodiment, the first coupling portions 28-3 may be openings that pass through the pad unit 28 in the z direction. In an embodiment, a screw hole for screw-fastening a fixing unit 29 (see FIG. 14A) may be defined in the first coupling portions 28-3, and the details may be described below. FIG. 13 illustrates that a total of six pairs of first coupling portions 28-3 along the x direction. However, the disclosure is not limited thereto. That is, the number of first coupling potions 28-3 may be more or less than six pairs.

Second coupling portions 28-4 may be arranged at a center portion of the pad unit 28. In an embodiment, the second coupling portions 28-4 may be openings that pass through the pad unit 28 in the z direction. In an embodiment, the second coupling portions 28-4 overlap the 2nd-1 openings 27-3A (see FIG. 8) or the 2nd-2 openings 127-3D (see FIG. 11) described above and are connected by screws together.

FIG. 14A is a perspective view illustrating a coupling state of a display apparatus, a pad unit, and a fixing unit according to an embodiment.

As referring to FIG. 14A, the display apparatus 1 is disposed on the upper surface (e.g., the z direction surface) of the pad unit 28.

In an embodiment, at least a portion of each of the corners of the display apparatus 1 may overlap each of the first concave portions 28-1 of the pad unit 28. A side surface portion of the display apparatus 1 along the y direction may overlap the second concave portion 28-2 of the pad unit 28. Accordingly, a portion of the corner and a portion of the side surface of the display apparatus 1 may be not supported by the pad unit 28 thereunder. Accordingly, for example, when a hit body is hit on a corner of the display apparatus 1, not only a crack but also a degree of bending deformation of the display apparatus 1 may be observed. Accordingly, not only the hardness but also the bending stress and tensile strength of the display apparatus 1 may be evaluated.

The fixing unit 29 may be disposed on the display apparatus 1 and the pad unit 28. In other words, the display apparatus 1 may be interposed between the pad unit 28 and the fixing unit 29. The fixing unit 29 may include a fixing stick 29-1 and a fastening unit 29-2. In an embodiment, the fixing stick 29-1 may extend in the short-side direction of the pad unit 28 or in the x direction. In an embodiment, the length of the fixing stick 29-1 along the x direction may be greater than the length of the display apparatus 1 along the x direction.

In an embodiment, the fixing stick 29-1 may include a pair of screw holes may be arranged at both ends in the x direction and overlap a pair of first coupling portions 28-3 of the pad unit 28. The fastening unit 29-2 may include a pair of knob bolts, and each knob bolt may be simultaneously coupled to the screw hole of the fixing stick and the first coupling portion 28-3. When the fastening unit 29-2 is coupled and then tightened, the fixing stick 29-1 may press and fix the display apparatus 1 onto the pad unit 28. FIG. 14A illustrates that the fixing unit 29 is fixedly attached to one of the first coupling portions 28-3 located in the y direction.

FIG. 14B is a perspective view illustrating a coupling state of a display apparatus, a pad unit, and a fixing unit according to another embodiment.

Referring to FIG. 14B, a plurality of fixing units 29 are provided. In an embodiment, the plurality of fixing units 29 are coupled to the pad unit 28 at different positions. FIG. 14B illustrates an embodiment in which an additional fixing unit 29 is fixedly attached to one of the first coupling portions 28-3 located in the y direction, compared to the embodiment illustrated in FIG. 14A.

As illustrated in FIGS. 14A and 14B, the position, number, and arrangement interval of first coupling portions 28-3 may be variously modified, and the arrangement position and number of fixing units 29 may be variously modified as well. Moreover, in an additional embodiment, a buffer material (not shown) may be arranged between the fixing stick 29-1 and the display apparatus 1 to prevent the display apparatus 1 from being damaged due to the pressure applied by the fixing unit 29 to the display apparatus 1.

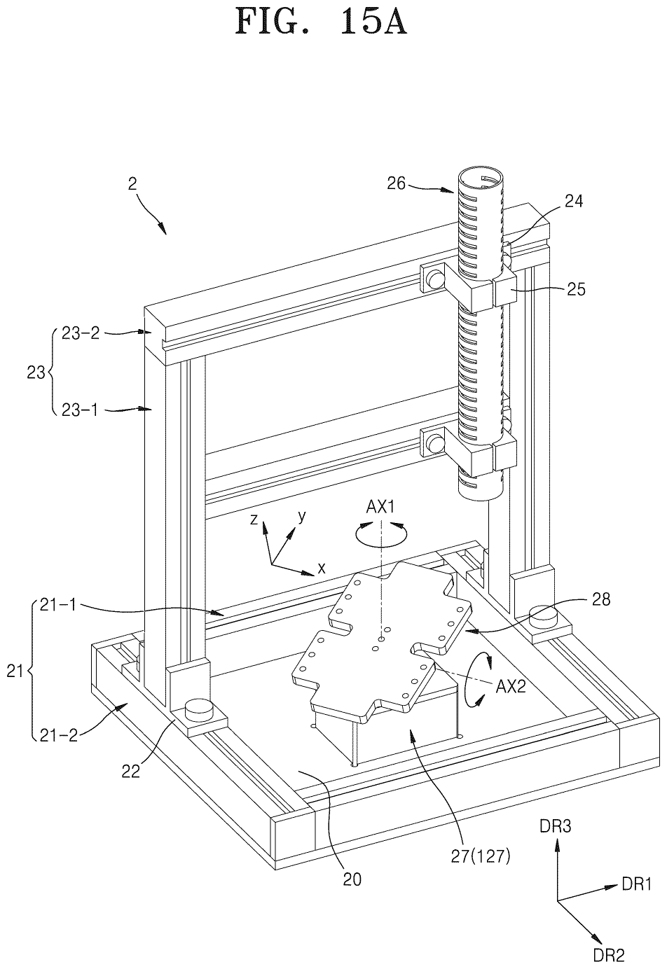

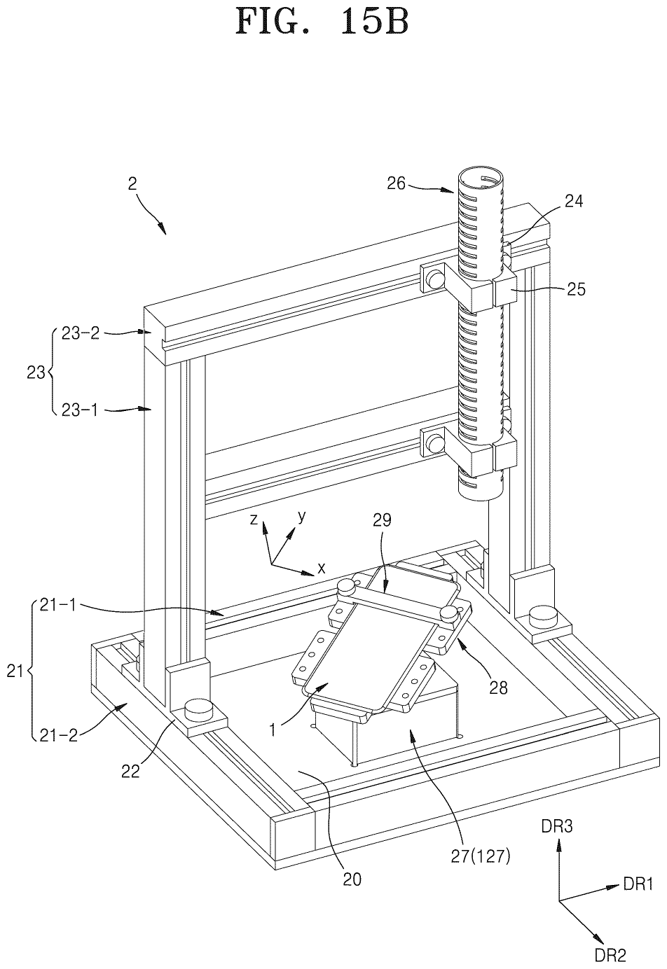

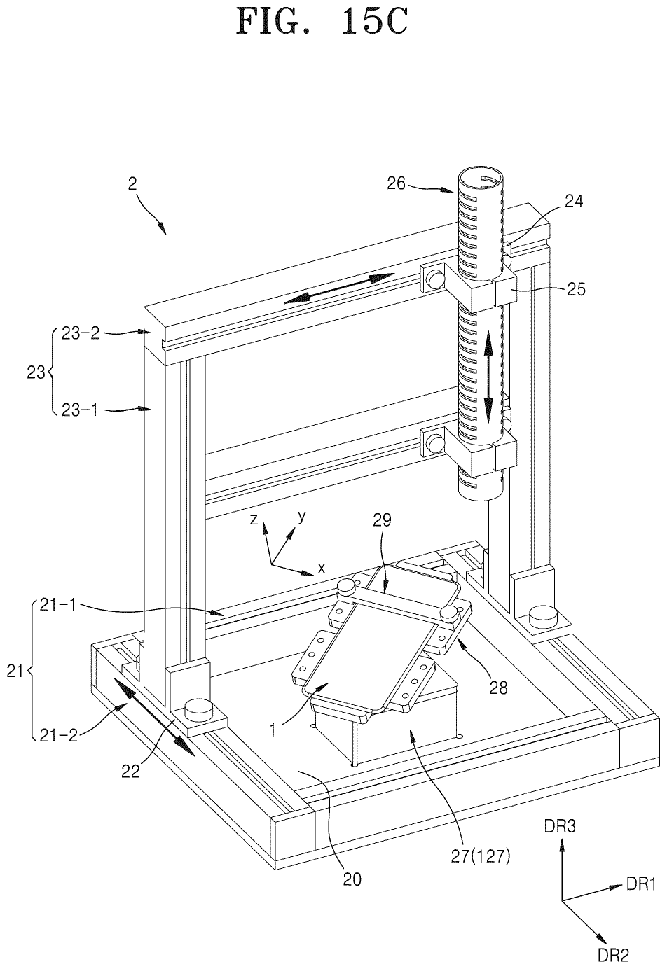

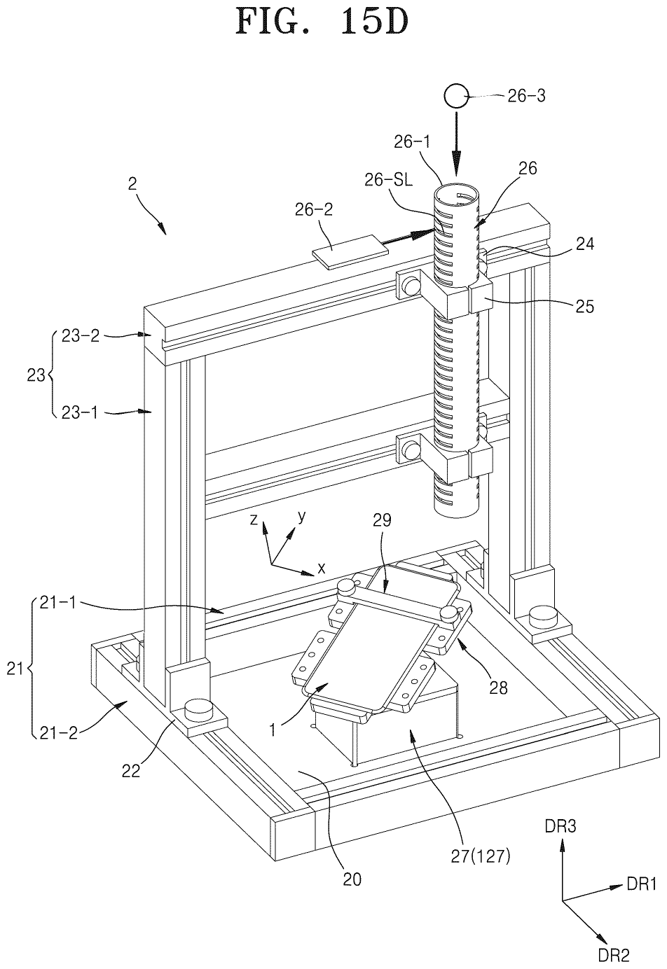

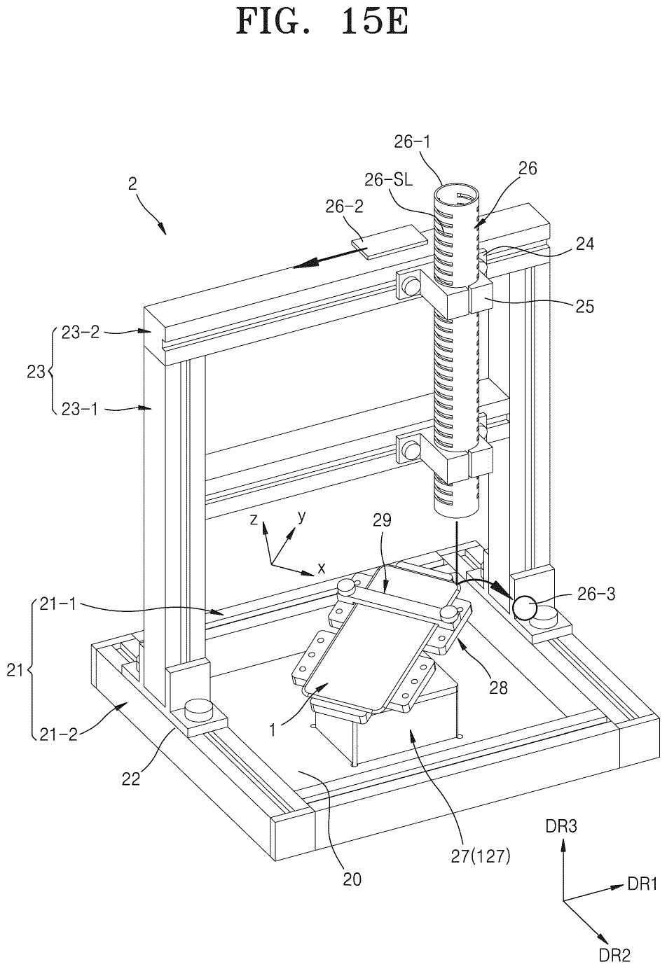

FIGS. 15A to 15E are perspective views illustrating process states of a testing method for a display apparatus according to an embodiment.

Hereinafter, for convenience of description, each of the operations of the testing method for a display apparatus will be described based on the display apparatus testing apparatus using the rotating unit 27 (see FIG. 8) illustrated in FIG. 8. However, the operations described below may be similarly applied to the display apparatus testing apparatus using the rotating unit 127 (see FIG. 11) illustrated in FIG. 11.

Referring to FIG. 15A, the angular position of the pad unit 28 is adjusted.

In an embodiment, the rotating unit 27 may be operated to rotate the pad unit 28 around the first axis AX1 and/or the second axis AX2. The long-side direction of the pad unit 28, for example, the y direction, may be different from the first direction DR1. The short-side direction of the pad unit 28, for example, the x direction, may be different from the second direction DR2. The upper-surface direction of the pad unit 28, for example, the z direction, may be different from the third direction DR3. The angular position of the pad unit 28 may vary depending on the angle at which the hit body is to be hit on the pad unit 28.

In another embodiment, when the display apparatus testing apparatus 2 includes the rotating unit 127 illustrated in FIG. 11, the pad unit 28 is rotated around the first axis AX1, the second axis AX2, and/or the third axis AX3 (see FIG. 11).

Referring to FIG. 15B, the display apparatus 1 as a testing target is mounted on the pad unit 28.

In an embodiment, the upper surface of the display apparatus 1 may be parallel to the upper surface of the pad unit 28. In other words, both the upper surface of the display apparatus 1 and the upper surface of the pad unit 28 may face in the z direction. In an embodiment, the long side of the display apparatus 1 may be parallel to the y direction. In an embodiment, the short side of the display apparatus 1 may be parallel to the x direction. A method of mounting the display apparatus 1 on the pad unit 28 using the fixing unit 29 is the same as that described with reference to FIGS. 13, 14A, and 14B.

FIG. 15B illustrates that one fixing unit 29 is coupled to the pad unit 28; however, the disclosure is not limited thereto. In another embodiment, as similar to the illustration in FIG. 14B, a plurality of fixing units 29 are used to fastened the pad unit 28 to the display apparatus 1 together.

FIGS. 15A and 15B illustrate that the display apparatus 1 is mounted after adjusting the angle of the pad unit 28. However, in another embodiment, the display apparatus 1 may be firstly mounted on the pad unit 28, and then the angle of the display apparatus 1 and the pad unit 28 are adjusted.

As referring to FIG. 15C, the position of the hit unit 26 is be adjusted as well.

The hit unit 26 may be translated and moved in the second direction DR2 using the first moving unit 22. The hit unit 26 may be translated and moved in the first direction D1 using the second moving unit 24. Thereafter, the hit unit 26 may be translated and moved in the third direction DR3 over the third support unit 25. As such, the hit unit 26 may be suitably moved in the first to third directions DR1, DR2, and DR3 to overlap the desired point (e.g., a corner) of the display apparatus 1. For example, the position of the hit unit 26 may be adjusted such that a center line (not illustrated) of the hit unit 26 may be located over a portion (e.g., a corner) of the display apparatus 1. Thus, the position of the hit unit 26 may be freely disposed on the display apparatus 1

As referring to FIG. 15D, after the guide unit 26-1 of the hit unit 26 is set to disposed over the desired position (e.g., a corner) of the display apparatus 1, the support stick 26-2 and the hit body 26-3 may be installed. A process of installing the support stick 26-2 and the hit body 26-3 in the guide unit 26-1 may be the same as that described above with reference to FIGS. 7A and 7B. In this case, the height of the hit body 26-3 before dropping (or the position in the third direction DR3) is adjusted according to the position of the slit 26-SL into which the support stick 26-2 is inserted. Thus, the height of the hit body 26-3 before dropping the hit body 26-3 (or the position in the third direction DR3) may vary depending on the third direction DR3 position of the guide unit 26-1 coupled to the third support unit 25 and the position of the slit 26-SL. The amount energy or force of the hit that the hit body 26-3 applies to the display apparatus 1, and the momentum that is obtained while dropping the hit body 26-3 may be determined according to the dropping distance thereof, and the dropping distance may vary depending on the height of the hit body 26-3 before dropping the hit body 26-3. In conclusion, the amount of the energy or force to be applied to the display apparatus 1 may vary depending on the position of the hit body 26-3 along third direction DR3 coupled with the position of the guide unit 26-1, the third support unit 25, and the slit 26-SL into which the support stick 26-2 is inserted.

As referring to FIG. 15E, the hit body 26-3 is dropped.

When the support stick 26-2 is removed, the hit body 26-3 seated on the support stick 26-2 may drop toward the display apparatus 1, for example, toward the corner of the display apparatus 1 and may hit on the display apparatus 1. Thereafter, the hit body 26-3 may be bounced offs in a certain direction. After dropping the hit body 26-3, the applied damage may be observed and determined by observing the display apparatus 1.

The testing method for a display apparatus according to an embodiment may adjust not only the drop position and height of the hit body 26-3 but also the angle at which the hit body 26-3 is incident on the display apparatus 1. For this purpose, the hit body 26-3 may be dropped in the gravity direction, and the angular position of the display apparatus 1 may be variously modified through the rotating units 27 and 127. Accordingly, the display apparatus 1 may be hit at various positions and angles, and not only the drop distance and the hit position but also the difference in damage depending on the hit angle may be identified.

As described above, according to an embodiment, a testing apparatus and a testing method for a display apparatus may be provided that may adjust not only an area of the display apparatus on which a hit body is hit but also an angle at which the hit body hits on the display apparatus. However, the scope of the disclosure is not limited to these effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A testing apparatus for a display apparatus, the testing apparatus comprising:
a base;
a hit unit mounted on the base to translate in a first direction, a second direction, and a third direction perpendicular to each other; and
a pad unit mounted on the base to rotate around a first axis and a second axis, wherein the first axis is perpendicular to an upper surface of the base, and the second axis is perpendicular to the first axis,
wherein the display apparatus is disposed on the pad unit.

2. The testing apparatus of claim 1, wherein the display apparatus includes a flat area and a curved area, and
the second axis rotates around the first axis.

3. The testing apparatus of claim 1, further comprising:
a support member attached to the base; and
a rotating member including a first rotating member and a second rotating member,
wherein the first rotating member of the rotating member is connected to the base, and is rotatable with respect to the base,
the second rotating member of the rotating member is connected to the first rotating member and is rotatable with respect to the first rotating member, and
wherein the pad unit is disposed on the second rotating member.

4. The testing apparatus of claim 1, wherein the pad unit is mounted on the base to be rotatable around the first axis, the second axis, and a third axis and,
the third axis is perpendicular to the second axis and extends in a different direction than the first axis.

5. The testing apparatus of claim 4, further comprising:
a socket unit rotating around the first axis with respect to the base; and
a sphere unit partially arranged in the socket unit and rotating around the second axis and the third axis,
wherein the pad unit is disposed on the sphere unit.

6. The testing apparatus of claim 1, further comprising an angle indicating unit configured to read an angular position of the pad unit on the first axis or the angular position of the pad unit on the second axis.

7. The testing apparatus of claim 1, further comprising an angle fixing unit configured to fix the pad unit at a certain angular position.

8. The testing apparatus of claim 1, further comprising a fixing unit mounted on the pad unit to fixedly attach the display apparatus to the pad unit together.

9. The testing apparatus of claim 1, wherein the hit unit includes: a hit body arranged to drop toward the display apparatus along a gravity direction.

10. The testing apparatus of claim 1, wherein the pad unit includes a concave portion arranged in a side or corner of the pad unit, and
at least a portion of the concave portion overlaps an edge of the display apparatus.

11. A testing method for a display apparatus, the testing method comprising:
mounting the display apparatus on a testing apparatus for the display apparatus; and
dropping a hit body on a desired position of the display apparatus,
wherein the testing apparatus includes:
a base;
a hit unit mounted on the base to translate in a first direction, a second direction, and a third direction perpendicular to each other; and
a pad unit mounted on the base to rotate around each of a first axis and a second axis, wherein the first axis is perpendicular to an upper surface of the base, and the second axis is perpendicular to the first axis, and
wherein the display apparatus is disposed on the pad unit.

12. The testing method of claim 11, wherein the display apparatus includes a flat area and a curved area, and
the second axis rotates around the first axis.

13. The testing method of claim 11, wherein the testing apparatus further includes:
a support member attached to the base; and
a rotating member including a first rotating member and a second rotating member,
wherein the first rotating member of the rotating member is connected to the base, and is rotatable with respect to the base,
the second rotating member of the rotating member is connected to the first rotating member and is rotatable with respect to the first rotating member, and
wherein the pad unit is disposed on the second rotating member.

14. The testing method of claim 11, wherein the pad unit is mounted on the base to be rotatable around the first axis, the second axis, and a third axis, and
the third direction is perpendicular to the second axis and extends in a different direction than the first axis.

15. The testing method of claim 14, wherein the testing apparatus further includes:
a socket unit rotating around the first axis with respect to the base; and
a sphere unit partially arranged in the socket unit and rotating around the second axis and the third axis, and
wherein the pad unit is disposed on the sphere unit.

16. The testing method of claim 11, further comprising reading an angular position of the pad unit disposed on the first axis or the angular position of the pad unit disposed on the second axis.

17. The testing method of claim 11, further comprising fixing the pad unit at a certain angular position.

18. The testing method of claim 11, wherein the testing apparatus further includes a fixing unit mounted on the pad unit to fixedly attach the display apparatus to the pad unit together.

19. The testing method of claim 11, wherein the dropping of the hit body on the desired position of the display apparatus is accomplished by dropping the hit body from a certain height toward the display apparatus along a gravity direction.

20. A testing apparatus for a display apparatus, the testing apparatus comprising:
a base;
first support members fixedly attached to the base;
second support members movably attached to the first support members to translate along a first direction;
a hit unit movably attached to the second support members to translate along a second direction perpendicular to the first direction;
a rotating member including a first rotating member and a second rotating member; and
a pad unit mounted on the rotating member to rotate around each of a first axis and a second axis, wherein the first axis is perpendicular to an upper surface of the base, and the second axis is perpendicular to the first axis,
wherein the first rotating member of the rotating member is attached to the base, and is rotatable with respect to the base,
the second rotating member of the rotating member is attached to the first rotating member and is rotatable with respect to the first rotating member, and
the hit unit is configured to guide a hit body on a desired position of the display apparatus along a third direction which is perpendicular to the first and second directions.
